(19) United States
(12) Patent Application Publication
(10) Pub. No.: US 2025/0334907 A1
(43) Pub. Date: Oct. 30, 2025

(54) IMAGE FORMING APPARATUS WITHOUT DEDICATED POWER SUPPLY FOR COMPARATOR REFERENCE VOLTAGE

(71) Applicant: BROTHER KOGYO KABUSHIKI KAISHA, Nagoya (JP)

(72) Inventors: Shuji KAWASAKI, Nagoya (JP); Yoshiyuki TSUJIMOTO, Nagoya (JP); Nobuyuki TANAKA, Konan (JP)

(73) Assignee: BROTHER KOGYO KABUSHIKI KAISHA, Nagoya (JP)

(21) Appl. No.: 19/088,269

(22) Filed: Mar. 24, 2025

(30) Foreign Application Priority Data
Apr. 26, 2024 (JP) 2024-072322

(51) Int. Cl. G03G 15/20; G03G 15/00

(52) U.S. Cl. CPC G03G 15/205; G03G 15/2032; G03G 15/2064; G03G 15/5004; G03G 15/80

(57) ABSTRACT

An image forming apparatus includes a first sensor, a first comparator, and a first power supply. The first sensor is configured to detect a physical quantity of the image forming apparatus and output a corresponding first sensor voltage. The first comparator is configured to receive the first sensor voltage and a first reference voltage, compare them, and output a first output signal when the first sensor voltage exceeds the first reference voltage. The first power supply is configured to be turned on or off depending on whether the image forming apparatus is in a first mode or a second mode that consumes less power than the first mode. Thereby, the first power supply outputs a specific voltage in the first mode, and does not output the specific voltage in the second mode. The specific voltage is used to generate the first sensor voltage and the first reference voltage.

### REFERENCE TO RELATED APPLICATIONS

This application claims priority from Japanese Patent Application No. 2024-072322 filed on Apr. 26, 2024. The entire content of the priority application is incorporated herein by reference.

### BACKGROUND ART

Heretofore, an image forming apparatus has been known that is configured to perform printing by heating a sheet with a toner image transferred thereon to fix the toner image on the sheet. The sheet is generally heated by a fuser heated by an energized heater. However, in order to inhibit the fuser from being overheated, an image forming apparatus including an overheating detection circuit having a comparator has been proposed.

For instance, a configuration has been disclosed in which a reference voltage is input to one input terminal of the comparator, and a voltage corresponding to a temperature of the fuser is input to the other input terminal, and when the voltage corresponding to the temperature of the fuser exceeds the reference voltage, a signal is transmitted to a control circuit and the heater is turned off.

### SUMMARY

In the disclosed configuration, a dedicated power supply is provided to input the reference voltage to the one input terminal of the comparator, which leads to the problem of increased costs.

Aspects of the present disclosure are advantageous in providing one or more improved techniques for an image forming apparatus that eliminates the need for a dedicated power supply to input a reference voltage to a comparator, thereby reducing costs compared to known configurations.

According to aspects of the present disclosure, an image forming apparatus is provided, which includes a first sensor, a first comparator, and a first power supply. The first sensor is configured to detect a first physical quantity of the image forming apparatus and to output a first sensor voltage corresponding to the detected first physical quantity. The first comparator includes a first sensor input terminal and a first reference voltage input terminal. The first sensor input terminal is configured to receive the first sensor voltage from the first sensor. The first reference voltage input terminal is configured to receive a first reference voltage. The first comparator is configured to compare the first sensor voltage with the first reference voltage and to output a first output signal when the first sensor voltage exceeds the first reference voltage. The first power supply is configured to be turned on or off depending on whether the image forming apparatus is in a first mode or a second mode that consumes less power than the first mode. Thereby, the first power supply outputs a specific voltage when the image forming apparatus is in the first mode, and does not output the specific voltage when the image forming apparatus is in the second mode. The specific voltage is used to generate the first sensor voltage and the first reference voltage.

### BRIEF DESCRIPTION OF DRAWINGS

FIG. 1 is a cross-sectional side view schematically showing a configuration of a printer.

FIG. 2 is a perspective view of the printer with a rear cover open.

FIG. 3 is a perspective view of the printer from which a fuser is removed.

FIG. 4 shows an internal configuration of the fuser as viewed from the front.

FIG. 5 shows the internal configuration of the fuser as viewed from the rear.

FIG. 6 illustrates a pressure contact/separation mechanism of the fuser.

FIG. 7 shows an electrical configuration of the printer.

FIG. 8 shows an electrical configuration with respect to a relay board in the fuser.

FIG. 9 shows an electrical configuration with respect to a hard limiter circuit provided on a main board.

FIG. 10 is a flowchart showing a procedure of a temperature abnormality detecting process.

FIG. 11 shows an electrical configuration with respect to a hard limiter circuit provided on a main board.

FIG. 12 shows an electrical configuration with respect to a hard limiter circuit provided on a main board.

FIG. 13 shows an electrical configuration with respect to a hard limiter circuit provided on a main board.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

In the present disclosure, an inclusive OR, meaning that it includes either A or B or both, may be expressed as “A and/or B,” “at least one of A or B,” or “at least one selected from the group consisting of A and B.” The same applies to a case where there are three or more selectable elements to consider.

The following describes a printer, which may be an example of an “image forming apparatus” according to aspects of the present disclosure, in first through fourth illustrative embodiments with reference to the accompanying drawings.

### First Illustrative Embodiment

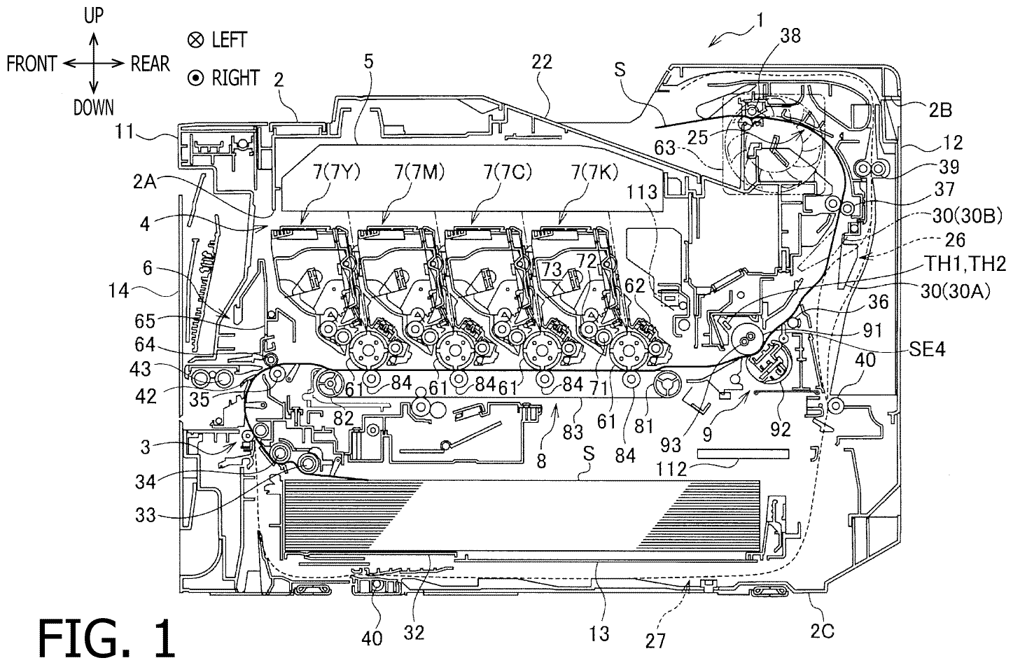

First, an overall configuration of a printer 1 in a first illustrative embodiment according to aspects of the present disclosure will be described. FIG. 1 schematically shows a configuration of the printer 1 in the first illustrative embodiment. In the following description, a front-rear direction, a left-right direction, and a vertical direction of the printer 1 are as shown in the relevant drawings.

### Overall Configuration of Printer

The printer 1 in the first illustrative embodiment is an electrophotographic color laser printer configured to print an intended image on a sheet S. However, the printer 1 may be a monochrome laser printer. The printer 1 includes a main body housing 2, a conveyor 3, a process unit 4, and a fuser 9 configured to be removably attached to the main body housing 2. The process unit 4 may be an example of an “image forming engine” according to aspects of the present disclosure.

The main body housing 2 includes a front cover 11, a rear cover 12, a feed tray 13, a discharge tray 22, a first conveyance path 25, a second conveyance path 26, and a third conveyance path 27. The front cover 11 is configured to open and close a front opening 2A provided at a front portion of the main body housing 2. The front cover 11 is attached to the front of the main body housing 2 in an openable and closable manner. The rear cover 12 is configured to open and close a rear opening 2B provided at a rear portion of the main body housing 2. The rear cover 12 is attached to the rear of the main body housing 2 in an openable and closable manner. The feed tray 13 is removably attached to a lower portion of the main body housing 2. The feed tray 13 is configured to support one or more sheets S placed thereon. The sheet S has a fixed size such as A4 size. For instance, the sheet S is a paper medium such as plain paper and cardboard. However, practicable examples of the sheet S are not limited to the above, but may include a transparency (i.e., an OHP film). The discharge tray 22 is disposed at an upper portion of the main body housing 2. The discharge tray 22 is configured to receive and support a discharged sheet S with an image formed thereon.

Further, a multipurpose tray (i.e., a manual feed tray) 14 is formed in a part of the front cover 11. The multipurpose tray 14 is configured to, when tilted forward, receive a sheet S manually fed therefrom. The printer 1 is configured to selectively perform printing not only on sheets S fed from the feed tray 13, but also on sheets S inserted from the multipurpose tray 14.

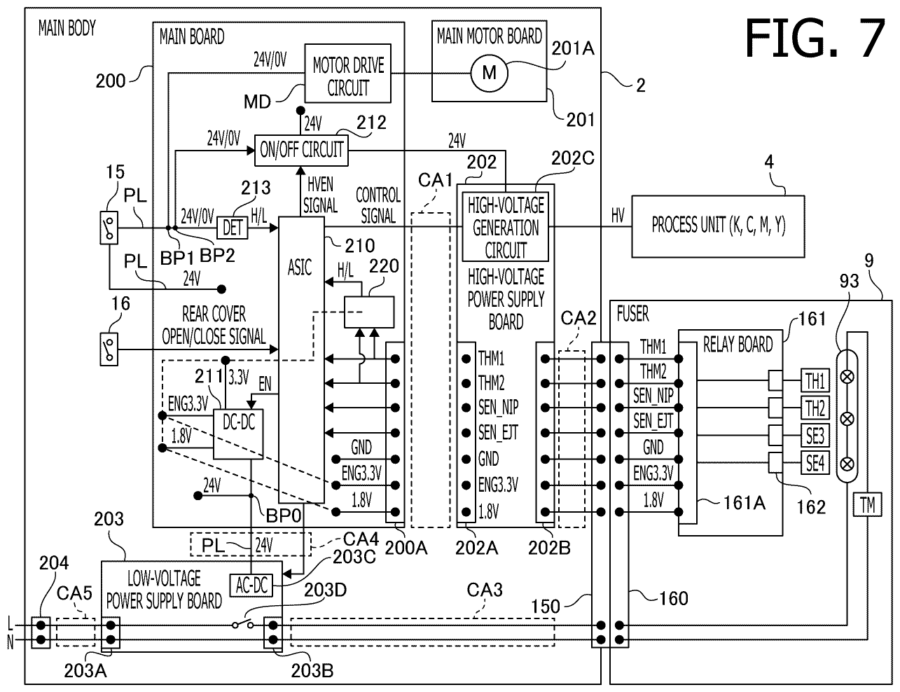

The conveyor 3 includes a pickup roller 33, a separation roller 34, a registration roller 35, a first conveyance roller 36, a second conveyance roller 37, a first switchback roller 38, a second switchback roller 39, a plurality of third conveyance rollers 40, a flapper 30, and a main motor 201A (see FIG. 7). A part of the second conveyance path 26 is formed by the closed rear cover 12.

The pickup roller 33 is configured to pick up sheets S in the feed tray 13 that are pressed upward by a sheet pressing plate 32 and to feed the sheets S toward the first conveyance path 25. The separation roller 34 is configured to separate the sheets S picked up by the pickup roller 33 on a sheet-by-sheet basis.

The registration roller 35 is disposed upstream of the process unit 4 in a conveyance direction along the first conveyance path 25. The registration roller 35 is configured to correct the misalignment of an orientation of a leading end of the sheet S, and then to convey the sheet S toward the process unit 4. The conveyance direction in which the registration roller 35 conveys the sheet S is a direction from the front to the rear.

To convey the sheet S out of the main body housing 2 with the rear cover 12 closed, the conveyor 3 conveys the sheet S from the process unit 4 by the first conveyance roller 36 and guides the sheet S to the first conveyance path 25 by the flapper 30 (30A). The conveyor 3 then conveys the sheet S guided to the first conveyance path 25, by the second conveyance roller 37 and the first switchback roller 38, and discharges the sheet S onto the discharge tray 22.

To convey the sheet S out of the main body housing 2 with the rear cover 12 open, the conveyor 3 conveys the sheet S from the process unit 4 by the first conveyance roller 36, guides the sheet S rearward by the flapper 30 (30B) swung to a position indicated by an imaginary line, and then discharges the sheet S onto the rear cover 12 in the open state through the rear opening 2B. The printer 1 is enabled to perform image formation on the sheet S even when the rear cover 12 is open. The rear cover 12 is configured to allow, in the open state, the sheet S with an image formed thereon to be discharged through the rear opening 2B.

To re-convey the sheet S to the process unit 4, the conveyor 3 conveys the sheet S conveyed from the process unit 4, by the first conveyance roller 36, and guides the sheet S to the first conveyance path 25 or the second conveyance path 26 by the flapper 30. When the sheet S has been guided to the first conveyance path 25, the conveyor 3 conveys the sheet S in the first conveyance path 25 to the third conveyance path 27 by the second conveyance roller 37 and the first switchback roller 38. When the sheet S has been guided to the second conveyance path 26, the conveyor 3 conveys the sheet S in the second conveyance path 26 to the third conveyance path 27 by the second switchback roller 39.

The sheet S conveyed to the third conveyance path 27 is fed to the process unit 4 again by the third conveyance roller 40 and the registration roller 35. The sheet S is then discharged onto the discharge tray 22 by the conveyor 3 after an image is formed on the sheet S by the process unit 4.

The conveyor 3 further includes a separation pad 42 and a pickup feed roller 43 for separating and feeding sheets S manually inserted from the multipurpose tray 14. Specifically, the separation pad 42 and pickup feed roller 43 are configured to separate the sheets S inserted from the multipurpose tray 14 on a sheet-by-sheet basis and to feed the separated sheets S to the process unit 4. The subsequent procedure is the same as in the aforementioned case where the sheets S are conveyed from the feed tray 13.

The process unit 4 is configured to transfer toner images onto the sheet S, thereby forming an image on the sheet S. The process unit 4 includes an exposure device 5, a drum unit 6, four developing cartridges 7Y, 7M, 7C, and 7K, and a transfer unit 8.

The exposure device 5 is disposed at an upper portion in the main body housing 2. The exposure device 5 includes a light source, a polygon mirror, a lens, and a reflector, which are not shown in any drawings. The exposure device 5 is configured to expose a surface of each photoconductive drum 61 by emitting a light beam, indicated by an alternate long and short dash line, onto the surface of each photoconductive drum 61.

The drum unit 6 is disposed between the feed tray 13 and the exposure device 5 in the main body housing 2. The drum unit 6 includes the four photoconductive drums 61, four electrostatic chargers 62, a pinch roller 64, and a support frame 65 that supports the photoconductive drums 61 and other elements. The drum unit 6 is configured to be removably attached to the main body housing 2 through the front opening 2A with the front cover 11 open. The pinch roller 64 is disposed to face the registration roller 35. The pinch roller 64 is configured to rotate in accordance with the rotation of the registration roller 35 and to convey the sheet S in cooperation with the registration roller 35.

The developing cartridges 7Y, 7M, 7C, and 7K correspond to four colors of yellow (Y), magenta (M), cyan (C), and black (K), respectively. The developing cartridges 7Y, 7M, 7C, and 7K are detachably mounted on the drum unit 6 in this order from the front to the rear of the printer 1. Each of the developing cartridges 7Y, 7M, 7C, and 7K has a developing roller 71, a supply roller 72, and a toner container 73. The developing cartridges 7Y, 7M, 7C, and 7K are for different toner colors, respectively, but otherwise have substantially the same configuration. Therefore, one of the developing cartridges 7Y, 7M, 7C, and 7K may be hereinafter referred to as the “developing cartridge 7” as a representative developing cartridge.

The transfer unit 8 is disposed between the feed tray 13 and the drum unit 6 in the main body housing 2. The transfer unit 8 includes a driving roller 81, a driven roller 82, a conveyor belt 83, and four transfer rollers 84. The conveyor belt 83 is wound around the driving roller 81 and the driven roller 82. An upward-facing side of the conveyor belt 83 is in contact with the photoconductive drums 61. The four transfer rollers 84 are disposed within a region surrounded by the conveyor belt 83 to sandwich the conveyor belt 83 between the transfer rollers 84 and the corresponding photoconductive drums 61.

The fuser 9 is disposed behind (i.e., disposed rearward of) the process unit 4 in the main body housing 2 when attached to the printer 1. More specifically, the fuser 9 is disposed between the rear cover 12 in the closed state and the process unit 4. The fuser 9 includes a heating roller 91 configured to heat the sheet S, and a pressure roller 92 configured to nip the sheet S between the pressure roller 92 and the heating roller 91. In the first illustrative embodiment, the heating roller 91 includes therein a heater 93 configured to heat the heating roller 91. As will be described later, the fuser 9 further includes a pressure contact/separation mechanism configured to switch between a pressure contact state in which the heating roller 91 is in pressure contact with the pressure roller 92 and a separation state in which the heating roller 91 is separated from the pressure roller 92. A detailed internal configuration of the fuser 9 will be described later.

The process unit 4 is configured to uniformly charge the surfaces of the photoconductive drums 61 by the respective chargers 62 and to expose the surfaces of the photoconductive drums 61 by the exposure device 5, thereby forming an electrostatic latent image on the surface of each photoconductive drum 61. In this case, the process unit 4 supplies toner in the toner containers 73 to the respective supply rollers 72 and supplies the toner from the supply rollers 72 to the respective developing rollers 71. The toner supplied to the developing rollers 71 is carried on the developing rollers 71 as the developing rollers 71 rotate.

The process unit 4 supplies the toner carried on the developing rollers 71 to the electrostatic latent images formed on the respective photoconductive drums 61, thereby forming a toner image on the surface of each photoconductive drum 61. The process unit 4 then transfers the toner images on the photoconductive drums 61 onto the sheet S while conveying the sheet S, fed from the feed tray 13 by the conveyor 3, between the photoconductive drums 61 and the conveyor belt 83. Thereafter, the process unit 4 conveys the sheet S to the fuser 9.

The fuser 9 fixes the toner images transferred onto the sheet S while conveying the sheet S between the heating roller 91 and the pressure roller 92, thereby forming an image on the sheet S.

In addition, the fuser 9 has a discharge sensor SE4 disposed at a downstream portion thereof in the conveyance direction. The discharge sensor SE4 is configured to detect whether the sheet S with the toner images fixed thereon by the fuser 9 has passed between the heating roller 91 and the pressure roller 92.

The printer 1 further includes a fixing fan 63 in the main body housing 2. The fixing fan 63 is configured to, when driven, exhaust air in the main body housing 2 out of the main body housing 2.

On the other hand, the fuser 9 includes two fixing temperature sensors TH1 and TH2 for detecting temperatures of the fuser 9 (more specifically, of the heating roller 91). Each of the fixing temperature sensors TH1 and TH2 includes a variable resistor whose resistance value changes depending on a temperature to be detected. Each of the fixing temperature sensors TH1 and TH2 is configured to output a signal according to the detected temperature. Each of the fixing temperature sensors TH1 and TH2 is disposed to face the heating roller 91 in a non-contact state. The fixing temperature sensors TH1 and TH2 have respective different detection target regions. Specifically, the fixing temperature sensor TH2 is configured to detect a temperature of a region around a center of the heating roller 91 in an axial direction of the heating roller 91. The fixing temperature sensor TH1 is configured to detect a temperature of a region around one end of the heating roller 91 in the axial direction of the heating roller 91.

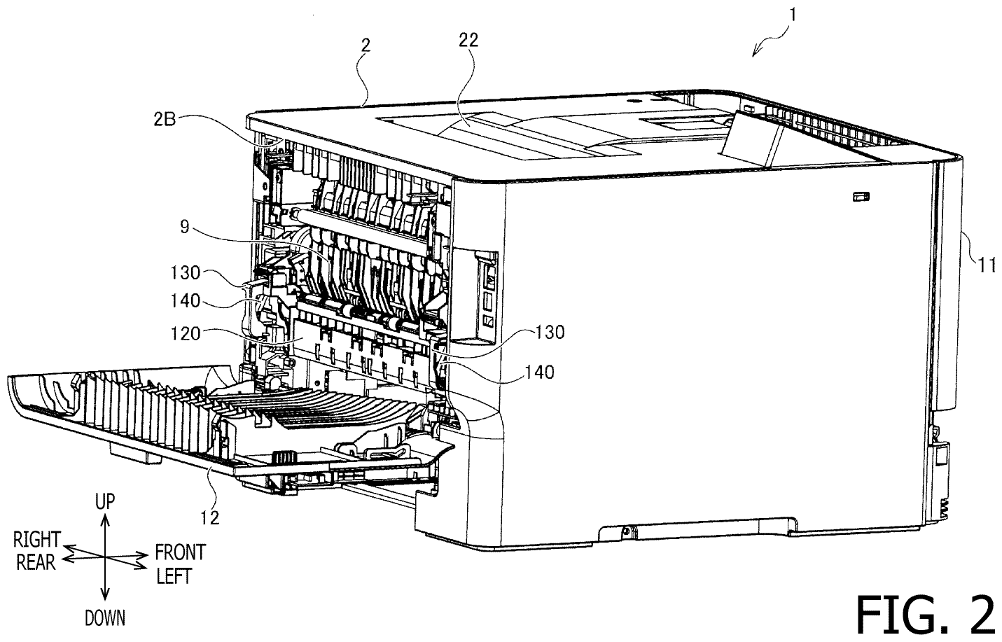

The fuser 9 is configured to be attached to and detached from the main body housing 2 through the rear opening 2B of the main body housing 2 that is opened when the rear cover 12 is opened. FIG. 2 shows the rear cover 12 opened. As shown in FIG. 2, the fuser 9 includes a fuser housing 120, fixed handles 130, and levers 140. The fixed handles 130 are disposed at both a left end portion and a right end portion of the fuser housing 120. Each fixed handle 130 has a corresponding lever 140 attached thereto.

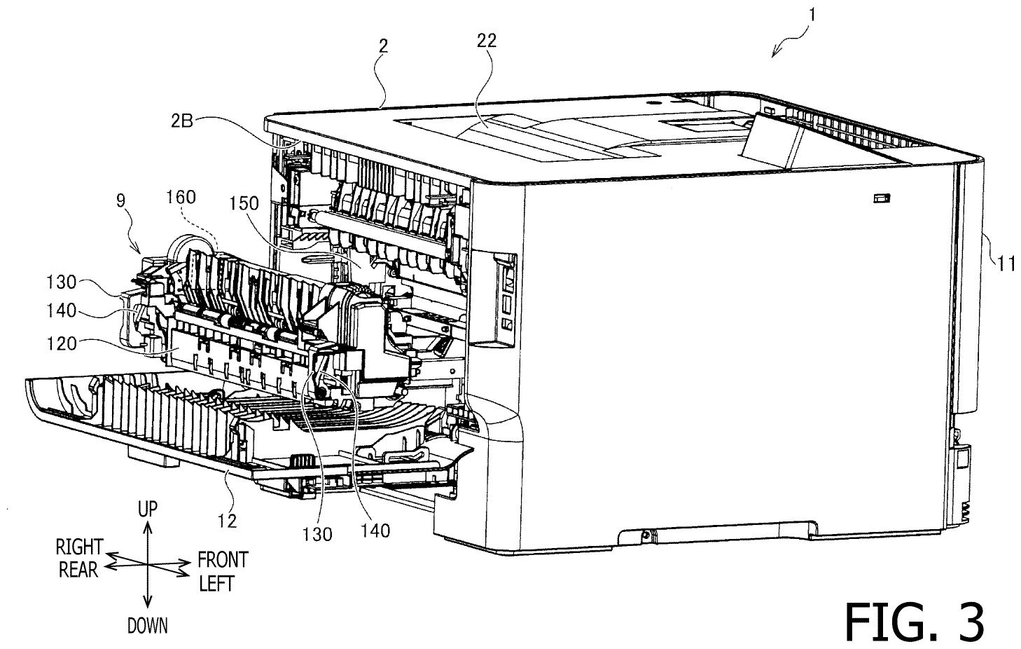

The user may detach the fuser 9 from the main body housing 2 as shown in FIG. 3 by pulling the fixed handles 130 backward while grasping the levers 140. At this time, a fuser connector 160 provided on the fuser 9 is also detached from a main body connector 150 provided on the main body housing 2. Namely, the fuser connector 160 and the main body connector 150 are connected to each other when the fuser 9 is attached to the main body housing 2, and are disconnected from each other when the fuser 9 is detached from the main body housing 2.

Although not shown in any drawings, the main body housing 2 includes a fuser detection switch 15 (see FIG. 7) disposed at a position where the main body housing 2 is in contact with the fuser 9 when the fuser 9 is attached to the main body housing 2. The fuser detection switch 15 is for detecting whether the fuser 9 is attached to the main body housing 2. Specifically, the fuser detection switch 15 is configured to be turned on when the fuser 9 is attached to the main body housing 2 and to be turned off when the fuser 9 is detached from the main body housing 2.

### Configuration of Fuser

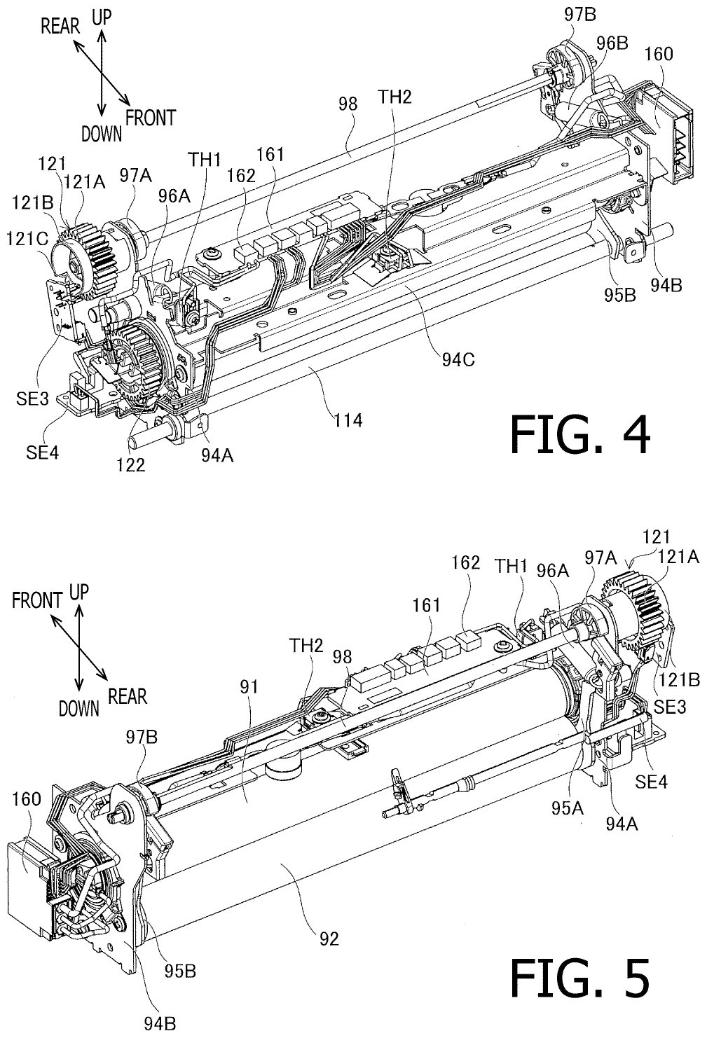

Next, among the aforementioned elements included in the printer 1, in particular, the fuser 9 configured to be detachably attached to the main body housing 2 and to fix toner images on a sheet S will be described in detail with reference to the relevant drawings. FIGS. 4 and 5 show internal configurations of the fuser 9 with an outer wall of the fuser housing 120 removed therefrom as viewed from the front and the rear, respectively. In the following description, the front-rear direction and the vertical direction are defined as indicated in the relevant drawings.

The fuser 9 includes the heating roller (hereinafter, which may be referred to as a “heating rotatable body”) 91 as an example of a heating member configured to heat a sheet S. The fuser 9 further includes the pressure roller (hereinafter, which may be referred to as a “pressure rotatable body”) 92 configured to nip the sheet S between the pressure roller 92 and the heating roller 91. The fuser 9 further includes side frames 94A and 94B, a connection frame 94C, arms 95A and 95B, springs 96A and 96B, and cams 97A and 97B.

The heating roller 91 extends in a longitudinal direction, and is rotatable around a rotation axis. The heating roller 91 is configured to rotate in response to receiving a driving force from the main motor 201A provided on the printer 1. The heating roller 91 includes a metal tube and the heater 93 disposed inside the metal tube. Thus, the heating roller 91 is further configured to be heated by the heater 93. For instance, the heater 93 is a halogen heater.

In the following description, the longitudinal direction of the heating roller 91 may be simply referred to as the “longitudinal direction.” The longitudinal direction is also the axial direction in which the rotation axis of the heating roller 91 extends. Therefore, the longitudinal direction may also be referred to as the axial direction. The sheet S is conveyed from the front to the rear of the fuser 9 and passes through the fuser 9. The sheet S, after passing through the fuser 9, is conveyed along the first conveyance path 25 toward a position above the fuser 9, as shown in FIG. 1.

The pressure roller 92 is configured to rotate in accordance with the rotation of the heating roller 91 and to nip the sheet S between the pressure roller 92 and the heating roller 91. For instance, the pressure roller 92 is made of an elastic material such as rubber.

The side frames 94A and 94B are disposed close to one end and the other end of the heating roller 91 in the longitudinal direction, respectively. Further, the side frames 94A and 94B are disposed close to one end and the other end of the pressure roller 92 in the longitudinal direction, respectively. The heating roller 91 is rotatably supported by the side frames 94A and 94B.

The connection frame 94C is a metal plate extending in the longitudinal direction. The connection frame 94C connects the side frame 94A on one side (hereinafter, which may be referred to as the “first side”) in the longitudinal direction with the side frame 94B on the other side (hereinafter, which may be referred to as the “second side”) in the longitudinal direction. It is noted that the first side and the second side in the longitudinal direction correspond substantially to the left and the right in the left-right direction, respectively.

The cam 97A is disposed close to the side frame 94A and is supported to be rotatable relative to the side frame 94A. The cam 97B is disposed close to the side frame 94B and is supported to be rotatable relative to the side frame 94B. The cam 97A and the cam 97B are connected to each other by a cam shaft 98.

The arms 95A and 95B, the springs 96A and 96B, and the cams 97A and 97B are included in the pressure contact/separation mechanism configured to switch between the pressure contact state in which the heating roller 91 and the pressure roller 92 are in pressure contact with each other to nip the sheet S therebetween and the separation state in which the heating roller 91 and the pressure roller 92 are separated from each other. More specifically, the pressure contact/separation mechanism is configured to move at least one of the heating roller 91 and the pressure roller 92 with respect to the other, thereby switching between the pressure contact state (in which even a nip pressure between the heating roller 91 and the pressure roller 92 is adjustable) and the separation state. In particular, in the first illustrative embodiment, the pressure contact/separation mechanism is configured to switch between the pressure contact state and the separation state by moving the pressure roller 92 with respect to the heating roller 91.

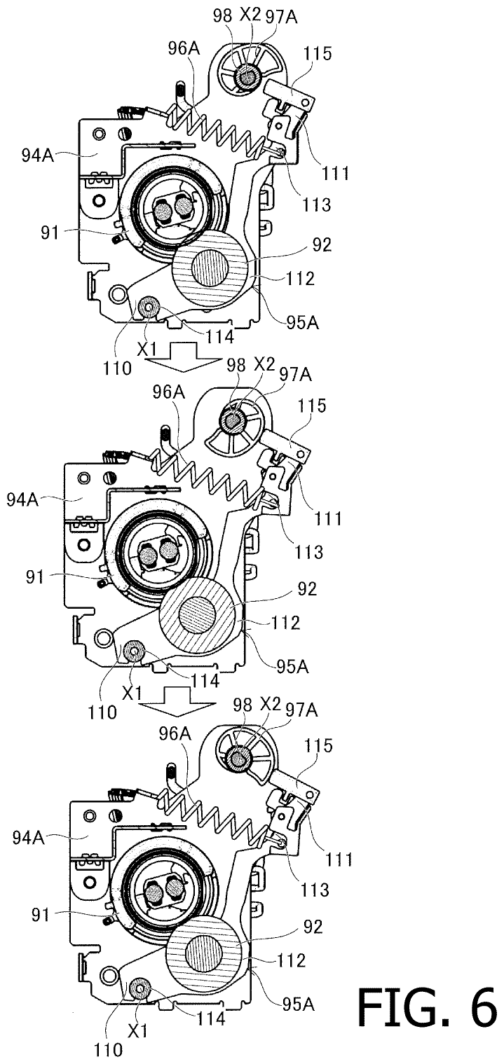

The pressure contact/separation mechanism will be described below with reference to FIG. 6. The operations of the arm 95A, the spring 96A, and the cam 97A in the side frame 94A are substantially the same as the operations of the arm 95B, the spring 96B, and the cam 97B in the side frame 94B. Therefore, the following describes the operations of the arm 95A, the spring 96A, and the cam 97A in the side frame 94A with examples.

As shown in FIG. 6, the arm 95A includes a first end portion 110, a second end portion 111, a first section 112, and a second section 113. The arm 95A is supported by the side frame 94A through a shaft 114 in such a manner that the first end portion 110 is rotatable around an arm axis X1. In addition, the second end portion 111 includes a cam follower 115. The cam follower 115 is configured to contact the cam 97A.

The first section 112 and the second section 113 are disposed between the first end portion 110 and the second end portion 111. The first section 112 rotatably supports the pressure roller 92. The second section 113 is a section to which the spring 96A is connected. One end of the spring 96A is hooked to the second section 113. The other end of the spring 96A is hooked to the side frame 94A. The spring 96A is configured to urge the pressure roller 92 toward the heating roller 91 through the arm 95A.

The cam 97A is supported by the side frame 94A on the first side in the longitudinal direction through the cam shaft 98 so as to be rotatable around a cam axis X2. The cam 97A has an irregular semicircular shape as shown in FIG. 6. The cam 97A is configured to rotate and come into contact with the cam follower 115, thereby rotating the arm 95A around the arm axis X1. The cam 97A is further configured to move the pressure roller 92 relative to the heating roller 91 in accordance with the rotation of the arm 95A, thereby switching between the pressure contact state and the separation state. The cam 97A is rotatable in a counterclockwise direction as shown in FIG. 6.

An upper drawing in FIG. 6 shows the pressure contact state in which the heating roller 91 and the pressure roller 92 are in pressure contact with each other. A lower drawing in FIG. 6 shows the separation state in which the heating roller 91 and the pressure roller 92 are separated from each other. A middle drawing in FIG. 6 shows a state in transition from the pressure contact state to the separation state.

Next, referring back to FIGS. 4 and 5 to continue the explanation of the fuser 9, the fuser 9 further includes a cam gear 121 and a fixing gear 122. The cam gear 121 is fixed to a first-side end portion of the cam shaft 98 in the longitudinal direction (i.e., the cam gear 121 is fixed substantially to the left end portion of the cam shaft 98 in the left-right direction). The cam gear 121 is connected to the cam 97A and the cam 97B through the cam shaft 98. The cam gear 121 is configured to transmit a driving force to the cam 97A and the cam 97B. The cam gear 121 includes a plurality of gear teeth 121A and a flange 121B. The flange 121B extends from near a base of the gear teeth 121A to the first side in the longitudinal direction (i.e., the flange 121B extends from near the base of the gear teeth 121A substantially to the left in the left-right direction). The flange 121B has a notch 121C for detecting a phase of the cam 97A.

The fixing gear 122 includes a plurality of gear teeth. The fixing gear 122 is fixed to a first-side end portion of the heating roller 91 in the longitudinal direction. The fixing gear 122 is disposed coaxially with the heating roller 91. The fixing gear 122 is configured to rotate around the rotation axis integrally with the heating roller 91 and to transmit a driving force to the heating roller 91.

Furthermore, the fuser 9 includes the fixing temperature sensors TH1 and TH2 configured to detect the temperatures of the heating roller 91, a nip detection sensor SE3, the discharge sensor SE4, the fuser connector 160, and a relay board 161.

The fixing temperature sensor TH1 is configured to detect a temperature of a region around one end of the heating roller 91 in the axial direction of the heating roller 91. As shown in FIG. 4, the fixing temperature sensor TH1 is fixed to the connection frame 94C, e.g., by screws in a position spaced upward from the heating roller 91, at an end portion (close to the side frame 94A) of the fuser 9 in the longitudinal direction. For instance, the fixing temperature sensor TH1 includes a thermistor. Specifically, the fixing temperature sensor TH1 includes a variable resistor configured to change its resistance value depending on a temperature to be detected. The fixing temperature sensor TH1 is configured to output a signal according to the detected temperature.

On the other hand, the fixing temperature sensor TH2 is configured to detect a temperature of a region around a center of the heating roller 91 in the axial direction of the heating roller 91. As shown in FIG. 4, the fixing temperature sensor TH2 is fixed to the connection frame 94C, e.g., by screws in a position spaced upward from the heating roller 91, at a middle portion of the fuser 9 in the longitudinal direction. For instance, the fixing temperature sensor TH2 includes a thermistor. Specifically, the fixing temperature sensor TH2 includes a variable resistor configured to change its resistance value depending on a temperature to be detected. The fixing temperature sensor TH2 is configured to output a signal according to the detected temperature.

The nip detection sensor SE3 is configured to detect a phase of the cam 97A. More specifically, the nip detection sensor SE3 is an optical sensor that includes a light-emitting section configured to emit light, and a light-receiving section configured to receive the light from the light-emitting section. In the pressure contact state in which the heating roller 91 and the pressure roller 92 are in pressure contact with each other as shown in the upper drawing of FIG. 6, the light from the light-emitting section is blocked by the gear (specifically, the flange 121B of the cam gear 121) included in the pressure contact/separation mechanism. On the other hand, in the separated state in which the heating roller 91 and the pressure roller 92 are separated from each other as shown in the lower drawing of FIG. 6, the light from the light-emitting section is not blocked, and the light-receiving section is allowed to receive the light that has passed through the notch 121C formed in the flange 121B of the cam gear 121. As a result, as will be described later, the controller of the printer 1 is enabled to determine that the pressure contact/separation mechanism is in the separation state when the light-receiving section receives the light, and to determine that the pressure contact/separation mechanism is in the pressure contact state when the light-receiving section does not receive the light.

However, it is also possible to reverse the relationship between the light-blocking state detected by the nip detection sensor SE3 and the state of the pressure contact/separation mechanism by adjusting the position of the notch 121C in the flange 121B. Namely, the nip detection sensor SE3 may be configured to allow the light-receiving section to receive the light that has been emitted by the light-emitting section and passed through the notch 121C in the pressure contact state in which the heating roller 91 and the pressure roller 92 are in pressure contact with each other as shown in the upper drawing of FIG. 6. In this case, the nip detection sensor SE3 may be further configured to block the light from the light-emitting section in the separation state in which the heating roller 91 and the pressure roller 92 are separated from each other as shown in the lower drawing of FIG. 6. Thus, in this case, the controller of the printer 1 may be configured to determine that the pressure contact/separation mechanism is in the pressure contact state when the light-receiving section receives the light, and to determine that the pressure contact/separation mechanism is in the separation state when the light-receiving section does not receive the light.

The discharge sensor SE4 is configured to detect a sheet S that has passed between the heating roller 91 and the pressure roller 92, i.e., to detect a sheet S on which developer images have been fixed by the fuser 9. The discharge sensor SE4 includes an actuator configured to rotate around a rotation axis, and a photo sensor. When the sheet S, after passing between the heating roller 91 and the pressure roller 92, has come into contact with the actuator and has pushed the actuator down, the photo sensor near the rotation axis of the actuator detects that the actuator has been pushed down, i.e., that the sheet S has been discharged with the developer images fixed thereon by the fuser 9.

On the other hand, the fuser connector 160 is configured to be connected to the main body connector 150 (see FIG. 3) provided on the main body housing 2 of the printer 1 when the fuser 9 is attached to the main body housing 2. The fuser connector 160 is disposed outside the side frame 94B in the longitudinal direction.

The relay board 161 is configured to relay (i.e., transmit) the signals from the fixing temperature sensors TH1 and TH2, the nip detection sensor SE3, and the discharge sensor SE4 to the fuser connector 160. The relay board 161 includes a plurality of connectors (terminals) 162, each of which is configured to be connected to a corresponding sensor via a cable. The relay board 161 further includes another connector 162 configured to be connected to the fuser connector 160 via a cable.

In addition, the heater 93 of the heating roller 91 is connected to the fuser connector 160 by a power cable. Specifically, the heater 93 is connected to the fuser connector 160 by the power cable via a thermostat TM. The thermostat TM is configured to cut off the power supply when a temperature of the heating roller 91 exceeds a controllable range and becomes overheated.

When the fuser 9 having the above configuration is attached to the main body housing 2 of the printer 1, the fuser connector 160 is connected to the main body connector 150. When the fuser connector 160 and the main body connector 150 are connected to each other, the fuser 9 is enabled to transmit the temperature information detected by the fixing temperature sensors TH1 and TH2, the state of the pressure contact/separation mechanism detected by the nip detection sensor SE3, and the sheet information detected by the discharge sensor SE4 to the controller of the printer 1. In addition, when the fuser connector 160 and the main body connector 150 are connected to each other, the printer 1 is enabled to supply electric power to the heater 93 from a power supply board of the main body housing 2. The power supply board is controlled by the controller, and is configured to supply power to the heater 93 based on the temperature information detected by the fixing temperature sensors TH1 and TH2.

### Electrical Configuration of Printer

Next, an electrical configuration of the printer 1 including the fuser 9 will be described with reference to FIG. 7. FIG. 7 shows an electrical configuration of the printer 1 including the fuser 9. In FIG. 7, major components necessary to explain the first illustrative embodiment are shown, while the other components of the printer 1 may not be shown.

As shown in FIG. 7, the main body housing 2 includes a main board (i.e., a control board) 200, a main motor board 201, a high-voltage power supply board 202, and a low-voltage power supply board 203. The above boards are connected to each other via harnesses. The main motor 201A is mounted on the main motor board 201. When the main motor 201A is driven, the heating roller 91 of the fuser 9 and the rollers included in the conveyor 3 rotate.

The high-voltage power supply board 202 is configured to supply high voltages HV such as a developing voltage and a charging voltage to the process unit 4. The high-voltage power supply board 202 includes a high-voltage generation circuit 202C. The high-voltage generation circuit 202C is configured to generate the high voltages HV (e.g., voltages of around 1 kV) based on a DC voltage (e.g., 24 VDC) supplied from the low-voltage power supply board 203 via the main board 200, and to supply the generated high voltages HV to the process unit 4.

The main board 200 and the high-voltage power supply board 202 are connected to each other through a first connecting line CA1. An ASIC (“ASIC” is an abbreviation for “Application Specific Integrated Circuit”) 210 mounted on the main board 200 needs to send and receive control signals between the main board 200 and the high-voltage power supply board 202 in order to control the high-voltage power supply board 202. The first connecting line CA1 is used to transmit these control signals. In order to transmit a plurality of control signals, the first connecting line CA1 includes a plurality of signal lines. Therefore, the first connecting line CA1 is formed by a harness in which the plurality of signal lines are bundled.

The low-voltage power supply board 203 includes an AC-DC conversion circuit 203C. The low-voltage power supply board 203 is configured to receive an input of an AC voltage (e.g., 100 VAC) supplied from a commercial power supply, and to convert the received 100 VAC to a DC voltage (e.g., 24 VDC) using the AC-DC conversion circuit 203C. The low-voltage power supply board 203 is connected to the main board 200 via a fourth connecting line CA4. Thus, the low-voltage power supply board 203 is enabled to output the generated 24 VDC to the main board 200.

The main board 200 includes a DC-DC conversion circuit 211. The main board 200 is configured to convert the 24 VDC received from the low-voltage power supply board 203 to, for instance, 3.3 VDC using the DC-DC conversion circuit 211. The 3.3 VDC is a voltage used to drive various electronic components mounted on the main board 200. However, if there are electronic components configured to be driven by other DC voltages (e.g., 5 VDC), the main board 200 may include a plurality of DC-DC conversion circuits, and may be configured to generate the other DC voltages such as 5 VDC in addition to 3.3 VDC.

The DC-DC conversion circuit 211 is configured to generate voltages of 3.3 VDC and 1.8 VDC to be input to the fuser 9, in addition to the voltage(s) for driving the various electronic components mounted on the main board 200 described above. The voltage of 3.3 VDC is generated separately from the voltage of 3.3 VDC for driving various electronic components mounted on the main board 200, and will hereinafter be referred to as “ENG 3.3 V.” The voltages of ENG 3.3 V and 1.8 VDC are supplied to the fuser 9 via the main body connector 150 together with the ground potential. The relay board 161 included in the fuser 9 uses these supplied voltages and the ground potential to operate the fixing temperature sensors TH1 and TH2, the nip detection sensor SE3, and the discharge sensor SE4, and outputs the signal from each of the sensors to the ASIC 210. Specifically, the fixing temperature sensor TH1, the nip detection sensor SE3, and the discharge sensor SE4 operate at ENG 3.3 V. Meanwhile, the fixing temperature sensor TH2 operates at 1.8 VDC.

On the other hand, in addition to the 3.3 VDC, the voltages of ENG 3.3 V and 1.8 VDC as generated to be supplied to the fuser 9 are input to a hard limiter circuit 220 of the various electronic components mounted on the main board 200. The hard limiter circuit 220 is a circuit for detecting overheating. Specifically, the hard limiter circuit 220 is configured to, when at least one of the temperatures detected by the fixing temperature sensors TH1 and TH2 has exceeded a particular temperature, transmit to the ASIC 210 a signal (hereinafter, which may be referred to as a “heater hard limiter signal”) indicating that it has been detected that at least one of the temperatures detected by the fixing temperature sensors TH1 and TH2 has exceeded the particular temperature. The hard limiter circuit 220 uses the voltages of ENG 3.3 V and 1.8 VDC as reference voltages for comparators, in addition to the 3.3 VDC. In the first illustrative embodiment, the voltages of ENG 3.3 V and 1.8 VDC are used, as sensor voltages to be input to the comparators, to operate the fixing temperature sensors TH1 and TH2, and are also used as the reference voltages for the comparators. Therefore, there is no need to separately provide dedicated power supplies for inputting the reference voltages to input terminals of the comparators. Furthermore, a plurality of types of power supplies are used to drive the fixing temperature sensors TH1 and TH2 and also to input the reference voltages to the comparators. Therefore, even if a power supply line is cut, or the DC-DC conversion circuit 211 is broken, i.e., even if one of the voltages of ENG 3.3 V and 1.8 VDC is not available, it is possible to detect overheating using at least one of the fixing temperature sensors TH1 and TH2. A detailed explanation of the operation of the hard limiter circuit 220 will be given later.

In addition, the printer 1 changes its power consumption state from a “standby state” to a “sleep state” when a particular period of time has elapsed since the printer 1 entered the “standby state,” without receiving data related to image formation or an execution command for image formation. Hereinafter, the “standby state” may be referred to as the “first mode” or the “non-power-saving mode.” Further, the “sleep state” may be referred to as the “second mode” or the “power-saving mode.” The “sleep state” is a mode in which less power is consumed than in the “standby state.” For instance, when the printer 1 enters the “sleep state,” a display of the printer 1 is turned off, clock-down is performed to reduce an operating frequency of the CPU, and the supply of ENG 3.3 V is stopped. However, the voltages of 3.3 VDC and 1.8 VDC are continuously supplied. When the printer 1 has received data related to image formation or an execution command for image formation in the “sleep state,” the printer 1 changes its power consumption state back to the “standby state” and performs printing.

The low-voltage power supply board 203 is connected to the main body connector 150 via a third connecting line CA3, and is connected to an inlet (e.g., a plug or a terminal) 204 via a fifth connecting line CA5. The inlet 204 is configured to receive an input of the AC voltage (e.g., 100 VAC) supplied from the commercial power supply. The AC voltage is supplied from the inlet 204 to the fuser 9 via the fifth connecting line CA5, the low-voltage power supply board 203, the third connecting line CA3, the main body connector 150, and the fuser connector 160. The voltage supplied to the fuser 9 is supplied to the heater 93 via the thermostat TM.

The ASIC 210 mounted on the main board 200 includes, for instance, a CPU, a memory, and an input/output circuit (none of which are shown in any drawings). The ASIC 210 is configured to perform various types of arithmetic processing based on programs and data stored in the memory, thereby performing overall control of the printer 1 including the process unit 4. The memory is an embedded memory. The memory may be configured with a combination of a plurality of storage devices such as a ROM, a RAM, an NVRAM, an SSD, and an HDD. The memory is used when the ASIC 210 executes various programs.

In addition to the ASIC 210, the main board 200 further includes a motor drive circuit MD, an ON/OFF circuit 212, a detection circuit (DET) 213, the aforementioned hard limiter circuit 220, and the aforementioned DC-DC conversion circuit 211. The motor drive circuit MD is for driving the main motor 201A. The ON/OFF circuit 212 is configured to control whether to supply 24 VDC to the high-voltage generation circuit 202C of the high-voltage power supply board 202. The detection circuit (DET) 213 is configured to detect whether the fuser detection switch 15 for detecting whether the fuser 9 is attached to the main body housing 2 is in an ON state or in an OFF state.

The AC-DC conversion circuit 203C of the low-voltage power supply board 203 is connected to the DC-DC conversion circuit 211 via a power line PL. The power line PL connecting the AC-DC conversion circuit 203C and the DC-DC conversion circuit 211 to each other is included in the fourth connection line CA4 described above. The power line PL branches at a branching point BPO on the main board 200, and a branch of the power line PL extends to connect to an input side of the fuser detection switch 15.

An output side of the fuser detection switch 15 is connected to an input side of the ON/OFF circuit 212 via the power line PL. The power line PL extending from the output side of the fuser detection switch 15 branches at a first branching point BP1 located between the output side of the fuser detection switch 15 and the input side of the ON/OFF circuit 212, and a branch of the power line PL is connected to an input side of the motor drive circuit MD. Further, the power line PL extending from the output side of the fuser detection switch 15 to the input side of the ON/OFF circuit 212 branches at a second branching point BP2 located downstream of the first branching point BP1 in the extending direction of the power line PL, and a branch of the power line PL is connected to an input side of the detection circuit 213.

An output side of the motor drive circuit MD is connected to the main motor 201A. The motor drive circuit MD is supplied with the voltage applied to the first branch point BP1 on the power line PL. The output voltage from the fuser detection switch 15 is applied to the first branch point BP1. Therefore, when the fuser detection switch 15 is in the ON state, 24 VDC is applied to the first branch point BP1. Meanwhile, when the fuser detection switch 15 is in the OFF state, 0 V is applied to the first branch point BP1.

In addition, the motor drive circuit MD is configured to receive an input of a signal EN from an output port of the ASIC 210. The signal EN is a signal for enabling or disabling the motor drive circuit MD. For instance, when the value of the signal EN is H, the motor drive circuit MD is in an operable state. Meanwhile, when the value of the signal EN is L, the motor drive circuit MD is in an inoperable state. However, even if the signal EN of the value H is input to the motor drive circuit MD, the motor drive circuit MD does not operate as long as 24 VDC is not applied to the motor drive circuit MD. Specifically, when the signal EN of the value H is input to the motor drive circuit MD with 24 VDC applied, the motor drive circuit MD starts operating. Meanwhile, when the signal EN of the value L is input to the motor drive circuit MD with 24 VDC applied, the motor drive circuit MD stops operating. If 0 V is applied to the motor drive circuit MD, the motor drive circuit MD stops operating regardless of the value of the signal EN. Practicable examples of the method for the motor drive circuit MD to control the main motor 201A may include known methods. Therefore, an explanation of the method for the motor drive circuit MD to control the main motor 201A is omitted.

In addition, an output side of the ON/OFF circuit 212 is connected to an input side of the power supply voltage for the high-voltage generation circuit 202C of the high-voltage power supply board 202. The high-voltage generation circuit 202C is further configured to receive an input of a control signal from an output port (not shown) of the ASIC 210. For instance, the high-voltage generation circuit 202C includes a step-up circuit including a transformer, and a transformer drive circuit. As described above, the high-voltage generation circuit 202C is enabled to boost the input 24 VDC based on the input control signal and to supply the generated high voltages HV (specifically, including a charging voltage, a developing voltage, and a transfer voltage) to the process unit 4.

The ASIC 210 outputs an HVEN signal to the ON/OFF circuit 212. The HVEN signal is a signal for controlling the ON/OFF circuit 212. The HVEN signal takes one of the values ON (=H) and OFF (=L). While receiving an input of 24 VDC from the fuser detection switch 15, the ON/OFF circuit 212 switches whether or not to input 24 VDC to the high-voltage generation circuit 202C according to the value of the HVEN signal output from the ASIC 210.

An output side of the detection circuit 213 is connected to an input port (not shown) of the ASIC 210. When a value of a detection signal from the detection circuit 213 is L, the ASIC 210 determines that the fuser detection switch 15 is in the ON state. Meanwhile, when the value of the detection signal from the detection circuit 213 is H, the ASIC 210 determines that the fuser detection switch 15 is in the OFF state.

In addition, the input port of the ASIC 210 is connected to an output side of a rear cover open/close detection switch 16 for detecting whether the rear cover 12 is open or closed. The rear cover open/close detection switch 16 is disposed near the rear cover 12. The rear cover open/close detection switch 16 is configured to output a rear cover open/close signal indicating a value depending on whether the rear cover 12 is open or closed. The ASIC 210 is enabled to determine whether the rear cover 12 is open or closed based on the value of the rear cover open/close signal.

The main board 200 is connected to the high-voltage power supply board 202 via a connector 200A provided on the main board 200, the first connecting line CA1, and a connector 202A provided on the high-voltage power supply board 202. The high-voltage power supply board 202 is connected to the main body connector 150 via a connector 202B provided on the high-voltage power supply board 202 and the second connecting line CA2.

As described above, the main body housing 2 includes the inlet 204. The AC voltage supplied from the inlet 204 is input to the low-voltage power supply board 203 via a connector 203A provided on the low-voltage power supply board 203. The low-voltage power supply board 203 is connected to the main body connector 150 via a connector 203B provided on the low-voltage power supply board 203 and the third connecting line CA3.

When the fuser 9 is attached to the main body housing 2 of the printer 1, the main body connector 150 is connected to the fuser connector 160. The fuser connector 160 is connected to the relay board 161 of the fuser 9 via a connector 161A provided on the relay board 161. As described above, the fuser 9 includes the heater 93. The heater 93 is supplied with the AC voltage (e.g., 100 VAC) input from the inlet 204 via the low-voltage power supply board 203 (including a relay 203D), the third connecting line CA3, the main body connector 150, and the fuser connector 160.

The heater 93 is heated by the 100 VAC thus supplied. When 100 VAC is supplied to the heater 93, the ASIC 210 controls a heating temperature for the heater 93 by controlling the ON/OFF timing of the 100 VAC supplied to the heater 93.

The low-voltage power supply board 203 includes the relay 203D configured to turn the 100 VAC input on and off. The ASIC 210 is configured to output a relay ON/OFF signal from an output port (not shown) to the low-voltage power supply board 203, thereby performing ON/OFF control of the relay 203D. In particular, the ON/OFF control of the relay 203D is performed when the overheating of the fuser 9 is detected by the hard limiter circuit 220, as will be described later. In order to control this heating temperature for the fuser 9, the fixing temperature sensors TH1 and TH2 are provided as described above. The fixing temperature sensors TH1 and TH2 are configured with two sensors as shown in FIG. 4. The fixing temperature sensors TH1 and TH2 are disposed to detect temperatures of an end portion and a middle portion of the heating roller 91, respectively, which extends in the left-right direction (i.e., the longitudinal direction).

The fixing temperature sensor TH1 configured to detect the temperature of the end portion of the heating roller 91 is supplied with ENG 3.3 V from the relay board 161. The fixing temperature sensor TH1 operates at this ENG 3.3 V. The fixing temperature sensor TH2 configured to detect the temperature of the center portion of the heating roller 91 is supplied with 1.8 VDC. The fixing temperature sensor TH2 operates at this 1.8 VDC. A reason for using the fixing temperature sensors TH1 and TH2 having the different operating voltages as described above is that even if a power supply line is cut, or the DC-DC conversion circuit 211 is broken, at least one of the fixing temperature sensors TH1 and TH2 is available to detect a temperature of the heating roller 91. Furthermore, when the printer 1 changes its operational mode to the sleep state, the supply of ENG 3.3 V is stopped, but the supply of 1.8 VDC is maintained. Therefore, another reason for using the fixing temperature sensors TH1 and TH2 having the different operating voltages as described above is to operate the fixing temperature sensor TH2 even when the printer 1 enters the sleep state.

In order for the ASIC 210 on the main board 200 to control the heating temperature of the heater 93, signals THM1 and THM2 (i.e., signals THM1 and THM2 detected in the fuser 9) respectively corresponding to the temperatures detected by the fixing temperature sensors TH1 and TH2 are transmitted from the fuser 9 to the main board 200. More specifically, the signals THM1 and THM2 are transmitted to the main board 200 via the relay board 161, the fuser connector 160, the main body connector 150, the second connecting line CA2, the high-voltage power supply board 202, and the first connecting line CA1. The ASIC 210 on the main board 200 controls the ON/OFF timing of the 100 VAC to be supplied to the heater 93, based on the signals THM1 and THM2 from the fixing temperature sensors TH1 and TH2. Meanwhile, the signals THM1 and THM2 from the fixing temperature sensors TH1 and TH2 are also input to the hard limiter circuit 220. The hard limiter circuit 220 is configured to, when at least one of the temperatures detected by the fixing temperature sensors TH1 and TH2 has exceeded a particular temperature, transmit to the ASIC 210 a signal (i.e., a heater hard limiter signal) indicating that it has been detected that at least one of the temperatures detected by the fixing temperature sensors TH1 and TH2 has exceeded the particular temperature. In addition to the signals THM1 and THM2 from the fixing temperature sensors TH1 and TH2, the detection signals from the nip detection sensor SE3 and the discharge sensor SE4 are transmitted from the fuser 9 to the main board 200.

### Electrical Configuration of Relay Board

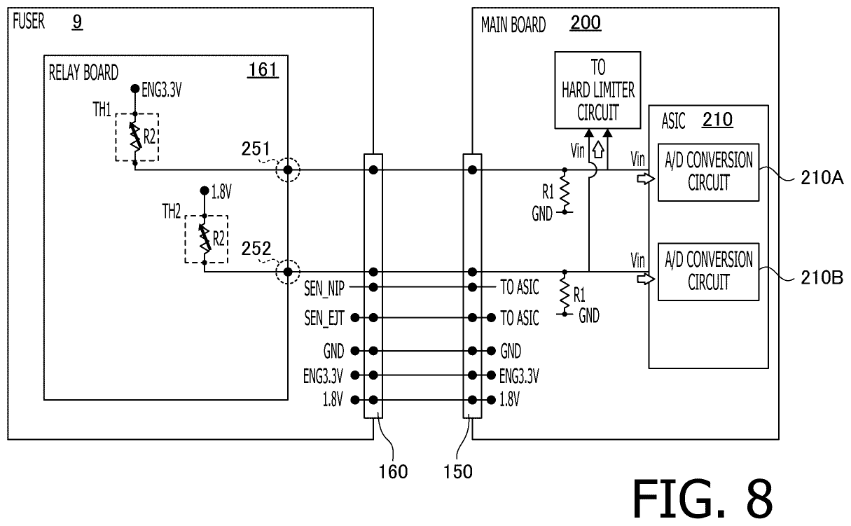

Next, with reference to FIG. 8, a more detailed explanation will be provided of an electrical configuration of the relay board 161 included in the fuser 9, among the aforementioned electrical configuration features of the printer 1. In particular, FIG. 8 shows only extracted features of an electrical configuration of the relay board 161 provided on the fuser 9 and a partial electrical configuration of the printer 1 associated with the relay board 161, among the electrical configuration features of the printer 1.

First, the fixing temperature sensor TH1 (i.e., the sensor configured to detect the temperature of the region around the one end of the heating roller 91 in the axial direction of the heating roller 91, see FIG. 4) of the fuser 9 will be described with reference to FIG. 8. The fixing temperature sensor TH1 includes a variable resistor R2 configured to change its resistance value depending on the temperature to be detected. The variable resistor R2 of the fixing temperature sensor TH1 is connected at one end to an ENG 3.3 V power supply provided on the relay board 161, and at the other end to a terminal of the fuser connector 160 via a signal line. The relay board 161 is configured to relay (i.e., transmit) the signal from the fixing temperature sensor TH1 to the main board 200 via an output terminal 251. The main board 200 includes a resistor R1 having a particular resistance value. The resistor R1 is connected at one end to a terminal of the ASIC 210, which is connected to the output terminal 251 and is configured to receive an input of the signal from the fixing temperature sensor TH1. The resistor R1 is further connected at the other end to the ground GND of the main board 200. For instance, the ground GND has a potential of 0 V. However, practicable examples of the potential of the ground GND are not limited to 0 V, but may include other potential values as long as they are usable as reference potentials. The same may apply to other grounds GND described below. The one end of the resistor R1 is also connected to the hard limiter circuit 220. The ASIC 210 includes an A/D conversion circuit 210A. Thus, according to the above electrical configuration with respect to the fixing temperature sensor TH1, an analog voltage obtained by dividing the voltage 3.3 V by the variable resistor R2 and the resistor R1 is input to the A/D conversion circuit 210A of the ASIC 210 and the hard limiter circuit 220. The ASIC 210 then identifies the temperature detected by the fixing temperature sensor TH1 using a digital value obtained through conversion by the A/D conversion circuit 210A. In addition, the hard limiter circuit 220 performs overheating detection of the fixing temperature sensor TH1.

An analog voltage (signal) Vin expressed by the following equation (1) is input to the A/D conversion circuit 210A and the hard limiter circuit 220.

$$Vin = EVG 3.3 V \times R 1 / ( variable R 2 + R 1 ) \qquad ( 1 )$$

As shown above, the analog voltage Vin changes as the resistance value of the variable resistor R2 changes depending on the change in temperature to be detected by the fixing temperature sensor TH1. It is noted that “R1” and “variable R2” in the equation (1) represent the respective resistance values of the resistor R1 and the variable resistor R2.

Next, the fixing temperature sensor TH2 (i.e., the sensor configured to detect the temperature of the region around the center of the heating roller 91 in the axial direction of the heating roller 91, see FIG. 4) of the fuser 9 will be described with reference to FIG. 8. The fixing temperature sensor TH2 includes a variable resistor R2 configured to change its resistance value depending on the temperature to be detected. The variable resistor R2 of the fixing temperature sensor TH2 is connected at one end to a 1.8 VDC power supply provided on the relay board 161, and at the other end to a terminal of the fuser connector 160 via a signal line. The relay board 161 is configured to relay (i.e., transmit) the signal from the fixing temperature sensor TH2 to the main board 200 via an output terminal 252. The main board 200 includes a resistor R1 having a particular resistance value. The resistor R1 is connected at one end to a terminal of the ASIC 210, which is connected to the output terminal 252 and is configured to receive an input of the signal from the fixing temperature sensor TH2. The resistor R1 is further connected at the other end to the ground GND of the main board 200. The one end of the resistor R1 is also connected to the hard limiter circuit 220. The ASIC 210 includes an A/D conversion circuit 210B. Thus, according to the above electrical configuration with respect to the fixing temperature sensor TH2, an analog voltage obtained by dividing the voltage 1.8 V by the variable resistor R2 and the resistor R1 is input to the A/D conversion circuit 210B of the ASIC 210 and the hard limiter circuit 220. The ASIC 210 then identifies the temperature detected by the fixing temperature sensor TH2 using a digital value obtained through conversion by the A/D conversion circuit 210B. In addition, the hard limiter circuit 220 performs overheating detection of the fixing temperature sensor TH2.

An analog voltage (signal) Vin expressed by the following equation (2) is input to the A/D conversion circuit 210B and the hard limiter circuit 220.

$$Vin = 1.8 VDC \times R 1 / ( variable R 2 + R 1 ) \qquad ( 2 )$$

As shown above, the analog voltage Vin changes as the resistance value of the variable resistor R2 changes depending on the change in temperature to be detected by the fixing temperature sensor TH2. It is noted that “R1” and “variable R2” in the equation (2) represent the respective resistance values of the resistor R1 and the variable resistor R2.

As described above, each of the fixing temperature sensors TH1 and TH2 is connected to the main board 200 with the corresponding resistor R1 provided thereon connected to the ground GND. Therefore, the corresponding analog voltage Vin indicates a potential value with the ground GND of not the relay board 161 but the main board 200 as a reference potential. This makes it possible to inhibit the ground deviation when analog-to-digital conversion is performed by each of the AD conversion circuits 210A and 210B, and to detect temperatures more accurately.

The voltages of ENG 3.3 V and 1.8 VDC from the power supplies provided on the relay board 161 are generated by the DC-DC conversion circuit 211 of the main board 200, and are supplied to the fuser 9 via the main body connector 150 together with the ground potential (see FIG. 8).

### Electrical Configuration of Hard Limiter Circuit

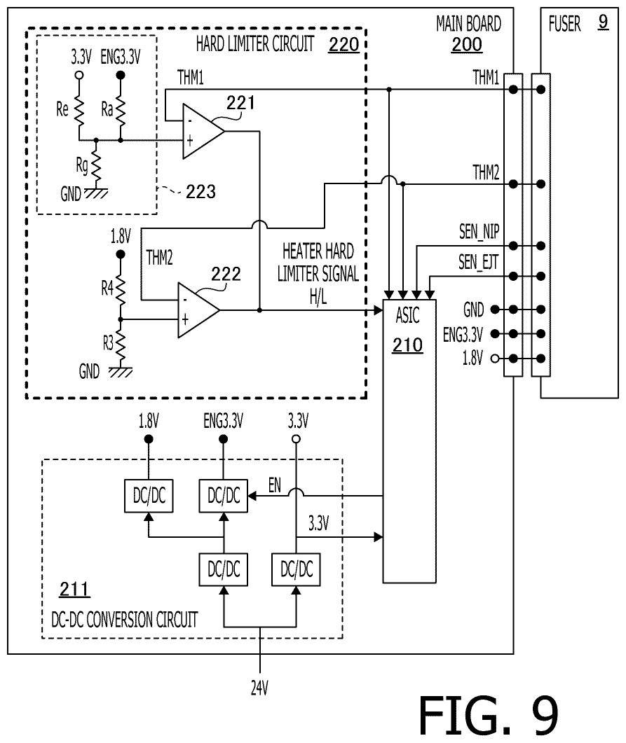

Next, with reference to FIG. 9, a detailed explanation will be provided in particular of an electrical configuration of the hard limiter circuit 220 provided on the main board 200 of the aforementioned electrical configuration of the printer 1. In particular, FIG. 9 shows only an electrical configuration with respect to the hard limiter circuit 220 provided on the main board 200, as extracted from the electrical configuration of the printer 1.

As shown in FIG. 9, the hard limiter circuit 220 includes a first comparator 221 for the fixing temperature sensor TH1, and a second comparator 222 for the fixing temperature sensor TH2. The first comparator 221 includes an inverting input terminal (−) and a non-inverting input terminal (+). The inverting input terminal (−) is a terminal into which the analog voltage Vin (hereinafter, which may be referred to as a “first sensor voltage”) expressed by the equation (1) is input from the fixing temperature sensor TH1. The inverting input terminal (−) may be referred to as a “first sensor input terminal.” The non-inverting input terminal (+) is a terminal into which a reference voltage (hereinafter, which may be referred to as a “first reference voltage”) is input. The non-inverting input terminal (+) may be referred to as a “first reference voltage input terminal.” The first sensor voltage Vin input from the inverting input terminal (−) is compared with the first reference voltage input from the non-inverting input terminal (+). When the first sensor voltage Vin exceeds the first reference voltage, an L signal (hereinafter, which may be referred to as a “first output signal”) is transmitted to the ASIC 210 as the heater hard limiter signal. On the other hand, when the first sensor voltage Vin is equal to or less than the first reference voltage, an H signal is transmitted to the ASIC 210 as the heater hard limiter signal. In response to receiving the L signal from the hard limiter circuit 220, the ASIC 210 turns off the relay 203D (see FIG. 7) on the low-voltage power supply board 203, thereby cutting off the input of the AC voltage to the heater 93.

The hard limiter circuit 220 further includes a reference voltage generation circuit 223 configured to generate the first reference voltage to be input to the non-inverting input terminal (+) of the first comparator 221. As shown in FIG. 9, the reference voltage generation circuit 223 has a first resistor Ra, a second resistor Re, and a third resistor Rg. One end of the first resistor Ra is connected to an ENG 3.3 V power supply (hereinafter, which may be referred to as a “first power supply”). One end of the second resistor Re is connected to a 3.3 VDC power supply (hereinafter, which may be referred to as a “particular power supply”). One end of the third resistor Rg is connected to the ground GND. The other ends of the first resistor Ra, the second resistor Re, and the third resistor Rg are connected at a junction. A voltage applied to the junction is input to the non-inverting input terminal (+) as the first reference voltage.

The first reference voltage Vd to be input to the non-inverting input terminal (+) is expressed by the following equation (3).

$$Vd = Rg \times ( Ra \times 3.3 VDC + R e \times ENG 3.3 V ) / ( Ra \times R e + R e \times Rg + Rg \times Ra ) \qquad ( 3 )$$

It is noted that “Ra,” “Re,” and “Rg” in the equation (3) represent the respective resistance values of the first resistor Ra, the second resistor Re, and the third resistor Rg.

As described above, the ENG 3.3 V power supply used to generate the first reference voltage is also used for the operating voltage of the fixing temperature sensor TH1 (see FIG. 8). Accordingly, in the first illustrative embodiment, the first sensor voltage Vin and the first reference voltage Vd are generated based on the voltage output from the same ENG 3.3 V power supply.

In addition, when the printer 1 is in the “sleep state” (i.e., the second mode, the power-saving mode), the supply of the ENG 3.3 V is stopped. Specifically, as shown in FIG. 9, the signal EN is input to the DC-DC conversion circuit 211 from the output port of the ASIC 210. When the printer 1 is in the standby state (including when printing is being performed), the ASIC 210 outputs the signal EN with a value of H (ON), thereby causing the DC-DC conversion circuit 211 to output the ENG 3.3 V When the printer 1 is in the sleep state, the ASIC 210 outputs the signal EN with a value of L (OFF), thereby causing the DC-DC conversion circuit 211 not to output the ENG 3.3 V.

Therefore, if the first reference voltage Vd is input solely from the ENG 3.3 V power supply, when the printer 1 enters the sleep state, the first reference voltage Vd to be input to the non-inverting input terminal (+) and the first sensor voltage Vin to be input to the inverting input terminal (−) will both become 0 V This may result in an indeterminate non-output logic state and a risk of false detection (e.g., a possibility that the L signal may be transmitted as the heater hard limiter signal even though the temperature of the heating roller 91 is sufficiently low). However, in the first illustrative embodiment, the non-inverting input terminal (+) to which the first reference voltage Vd is input is also connected to the 3.3 VDC power supply configured to supply 3.3 VDC even when the printer 1 is in the sleep state, in addition to the ENG 3.3 V power supply. Therefore, at least the voltage (hereinafter, which may be referred to as a “particular voltage”) from the 3.3 VDC power supply is still input to the non-inverting input terminal (+) even when the printer 1 is in the sleep state. As a result, the first reference voltage Vd does not become 0 V, thereby ensuring a definite output logic and inhibiting such false detection.

Comparing the above equations (1) and (3), if the ENG 3.3 V fluctuates, the first sensor voltage Vin and the first reference voltage Vd will fluctuate in the same increase/decrease direction. Therefore, in this case, it is possible to cancel out the fluctuation. On the other hand, the fluctuation in the 3.3 VDC does not affect the first sensor voltage Vin, but only the first reference voltage Vd. However, if Re>Ra, the fluctuation in the 3.3 VDC will have a greater effect on the first reference voltage Vd than the fluctuation in the ENG 3.3 V Therefore, it is possible to suppress detection errors caused by using the plurality of power supplies by making the resistance value of the resistor Re sufficiently larger than the resistance value of the resistor Ra.

The second comparator 222 has an inverting input terminal (−) and a non-inverting input terminal (+). The inverting input terminal (−) is a terminal into which the analog voltage Vin (hereinafter, which may be referred to as a “second sensor voltage”) expressed by the equation (2) is input from the aforementioned fixing temperature sensor TH2. Hereinafter, the inverting input terminal (−) may be referred to as a “second sensor input terminal.” The non-inverting input terminal (+) is a terminal into which a reference voltage (hereinafter, which may be referred to as a “second reference voltage”) is input. Hereinafter, the non-inverting input terminal (+) may be referred to as a “second reference voltage input terminal.” The second sensor voltage Vin input from the inverting input terminal (−) is compared with the second reference voltage input from the non-inverting input terminal (+). When the second sensor voltage Vin exceeds the second reference voltage, an L signal (hereinafter, which may be referred to as a “second output signal”) is transmitted to the ASIC 210 as the heater hard limiter signal. On the other hand, when the second sensor voltage Vin is equal to or less than the second reference voltage, an H signal is transmitted to the ASIC 210 as the heater hard limiter signal. In response to receiving the L signal from the hard limiter circuit 220, the ASIC 210 turns off the relay 203D (see FIG. 7) on the low-voltage power supply board 203, thereby cutting off the input of the AC voltage to the heater 93. Therefore, the ASIC 210 provides an instruction to disconnect the relay 203D when at least one of the following two conditions is satisfied. One of the two conditions is that the ASIC 210 has received the L signal from the first comparator 221, and the other is that the ASIC 210 has received the L signal from the second comparator 222.

As shown in FIG. 9, the non-inverting input terminal (+), into which the reference voltage is input, of the second comparator 222 is connected to a 1.8 VDC power supply (hereinafter, which may be referred to as a “second power supply”). The voltage obtained by dividing 1.8 V by a resistor R3 and a resistor R4 is input to the non-inverting input terminal (+) as the second reference voltage.

The second reference voltage Vd to be input to the non-inverting input terminal (+) is expressed by the following equation (4).

$$Vd = 1.8 VDC \times R 3 / ( R 3 + R 4 ) \qquad ( 4 )$$

It is noted that “R3” and “R4” in the equation (4) represent the respective resistance values of the resistors R3 and R4.

As described above, the 1.8 VDC power supply used to generate the second reference voltage is also used for the operating voltage of the fixing temperature sensor TH2 (see FIG. 8). Accordingly, in the first illustrative embodiment, the second sensor voltage Vin and the second reference voltage Vd are generated based on the voltage output from the same 1.8 VDC power supply.

Comparing the above equations (2) and (4), if the 1.8 VDC fluctuates, the second sensor voltage Vin and the second reference voltage Vd will fluctuate in the same increase/decrease direction. Therefore, in this case, it is possible to cancel out the fluctuation.

### Control Processing by Controller

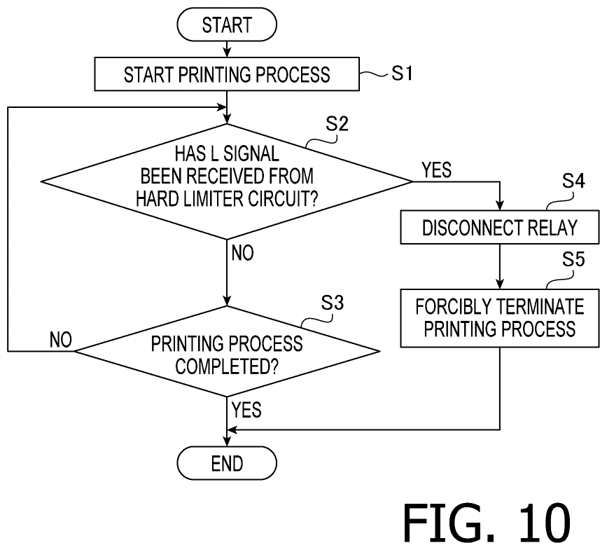

Next, with reference to FIG. 10, an explanation will be provided focusing on a process (hereinafter, which may be referred to as a “temperature abnormality detecting process”) to detect a temperature abnormality in the fuser 9 among various control processes to be performed by the ASIC 210 of the printer 1 configured as described above. FIG. 10 is a flowchart showing a procedure of the temperature abnormality detecting process in a main process to be performed after the printer 1 is turned on. The individual operations and processes shown in FIG. 10 are performed by the ASIC 210 (which may be an example of a “controller” according to aspects of the present disclosure), e.g., in accordance with a program or instructions stored in a memory (e.g., the memory of the ASIC 210) of the printer 1.

First, in S1, the ASIC 210 starts a printing process according to a print command. The print command is sent from an external device such as a PC connected to the printer 1 in a wired or wireless manner via a network interface of the printer 1 together with image data that is a target to be printed. In another instance, the ASIC 210 may start the printing process in response to receiving an execution command for image formation via a user interface of the printer 1. When printing is started, as shown in FIG. 6, the ASIC 210 causes the pressure contact/separation mechanism of the fuser 9 to switch from the separation state to the pressure contact state by rotating the cams 97A and 97B in the fuser 9 and moving the pressure roller 92 with respect to the heating roller 91. In addition to driving the process unit 4 and the main motor 201A, the ASIC 210 controls the ON/OFF timing of 100 VAC to be supplied to the heater 93 based on the signals THM1 and THM2 from the fixing temperature sensors TH1 and TH2.

Next, in S2, the ASIC 210 determines whether the L signal has been received from at least one of the first comparator 221 or the second comparator 222 of the hard limiter circuit 220. As described above, the first comparator 221 compares the first sensor voltage input from the inverting input terminal (−) with the first reference voltage input from the non-inverting input terminal (+). Then, if the first sensor voltage exceeds the first reference voltage, i.e., if the temperature detected by the fixing temperature sensor TH1 is higher than a reference value, the first comparator 221 transmits the L signal to the ASIC 210 as the heater hard limiter signal. Likewise, the second comparator 222 compares the second sensor voltage input from the inverting input terminal (−) with the second reference voltage input from the non-inverting input terminal (+). Then, if the second sensor voltage exceeds the second reference voltage, i.e., if the temperature detected by the fixing temperature sensor TH2 is higher than a reference value, the second comparator 222 transmits the L signal to the ASIC 210 as the heater hard limiter signal.

In response to receiving the H signal instead of the L signal from each of the first comparator 221 and the second comparator 222 of the hard limiter circuit 220, i.e., in response to determining that there is no temperature abnormality in the fuser 9 (S2: NO), the ASIC 210 proceeds to S3.

Thereafter, in S3, the ASIC 210 determines whether the printing process according to the print command has been completed.

In response to determining that the printing process according to the print command has been completed (S3: YES), the ASIC 210 terminates the temperature abnormality detecting process shown in FIG. 10. Meanwhile, in response to determining that the printing process according to the print command has not been completed (S3: NO), the ASIC 210 returns to S2 and continues to detect a temperature abnormality in the fuser 9.

On the other hand, in response to receiving the L signal from at least one of the first comparator 221 or the second comparator 222 of the hard limiter circuit 220, i.e., in response to determining that a temperature abnormality has occurred in the fuser 9 (S3: YES), the ASIC 210 provides an instruction to disconnect the relay 203D to the low-voltage power supply board 203 in order to suppress a further temperature rise in the fuser 9 (S4). Thus, the input of the AC voltage to the heater 93 is cut off. Then, the ASIC 210 forcibly terminates the printing process (S5) and also provides a warning that the printing process has been forcibly terminated.

As described in detail above, the printer 1 of the first illustrative embodiment is configured to set its operational mode to either the standby state or the sleep state. The standby state is the non-power-saving mode (i.e., the first mode). The sleep state is the power-saving mode (i.e., the second mode) that consumes less power than the non-power-saving mode. The printer 1 includes the fixing temperature sensor TH1, the first comparator 221, and the ENG 3.3 V power supply. The fixing temperature sensor TH1 is configured to detect a temperature of a first region of the heating roller 91 as a first physical quantity and to output the first sensor voltage corresponding to the detected temperature. The first comparator 221 includes the inverting input terminal (−) into which the first sensor voltage is input, and a non-inverting input terminal (+) into which the first reference voltage is input. The first comparator 221 is configured to compare the first sensor voltage with the first reference voltage, and to output the first output signal when the first sensor voltage exceeds the first reference voltage. The ENG 3.3 V power supply is controlled to output a specific voltage when the printer 1 is in the standby state, but not to output the specific voltage when the printer 1 is in the sleep state. The first sensor voltage and the first reference voltage are both generated based on the voltage output from the same ENG 3.3 V power supply. Therefore, there is no need to provide a separate power supply for inputting the first reference voltage to the non-inverting input terminal (+) of the first comparator 221. As a result, it is possible to achieve a cost reduction compared to known configurations.

The printer 1 further includes the fixing temperature sensor TH2, the second comparator 222, the 1.8 VDC power supply, and the ASIC 210. The fixing temperature sensor TH2 is configured to detect a temperature of a second region of the heating roller 91 as a second physical quantity and to output the second sensor voltage corresponding to the detected temperature. The second region is different from the first region. The second comparator 222 includes the inverting input terminal (−) into which the second sensor voltage is input, and the non-inverting input terminal (+) into which the second reference voltage is input. The second comparator 222 is configured to compare the second sensor voltage with the second reference voltage, and to output the second output signal when the second sensor voltage exceeds the second reference voltage. The 1.8 VDC power supply is configured to output the second reference voltage. The ASIC 210 is configured to receive the first output signal and the second output signal. Thus, with respect to the second physical quantity in addition to the first physical quantity, it is possible to detect that the second physical quantity (i.e., the second sensor voltage) exceeds the reference quantity (i.e., the second reference voltage) by comparing the second physical quantity and the reference quantity with the second comparator 222.

The printer 1 further includes the process unit 4 and the fuser 9. The process unit 4 is configured to form a developer image on a sheet S. The fuser 9 is configured to fix the developer image formed on the sheet S by the process unit 4. The fuser 9 includes the heating roller 91, the pressure roller 92, the inlet 204, and the heater 93. The heating roller 91 is configured to heat the sheet S. The pressure roller 92 is configured to nip the sheet S between the pressure roller 92 and the heating roller 91. The inlet 204 is configured to receive an input of the AC voltage supplied from the commercial power supply. The heater 93 is connected to the inlet 204 via the relay 203D. The fixing temperature sensor TH1 is configured to detect the temperature of the first region of the heating roller 91. The fixing temperature sensor TH2 is configured to detect the temperature of the second region of the heating roller 91. The second region is different from the first region. The ASIC 210 is configured to disconnect the relay 203D when at least one of the following two conditions is satisfied. One of the two conditions is that the ASIC 210 has received the first output signal from the first comparator. The other is that the ASIC 210 has received the second output signal from the second comparator. Thus, the ASIC 210 is enabled to detect that the detected temperature exceeds the reference quantity (i.e., the reference temperature) in at least one of the first region or the second region, thereby cutting of the power supply to the heater 93.

The printer 1 further includes the 3.3 VDC power supply configured to output 3.3 VDC. When the printer 1 is in the standby state, at least ENG 3.3 V is input to the non-inverting input terminal (+) of the first comparator 221. When the printer 1 is in the sleep state, at least 3.3 VDC is input to the non-inverting input terminal (+) of the first comparator 221. Thus, even if the printer 1 enters the sleep state, and the power supply from the ENG 3.3 V power supply is stopped, the first reference voltage will not be 0 V, ensuring a definite output logic and inhibiting false detection by the first comparator.

The printer 1 further includes the reference voltage generation circuit 223 configured to generate the first reference voltage to be input to the non-inverting input terminal (+) of the first comparator 221. The reference voltage generation circuit 223 includes the first resistor Ra, the second resistor Re, and the third resistor Rg. One end of the first resistor Ra is connected to the ENG 3.3 V power supply. One end of the second resistor Re is connected to the 3.3 VDC power supply. One end of the third resistor Rg is connected to the ground GND. The other ends of the first resistor Ra, the second resistor Re, and the third resistor Rg are connected at the junction. The voltage applied to the junction is input to the non-inverting input terminal (+) as the first reference voltage. If the ENG 3.3 V fluctuates, the first sensor voltage and the first reference voltage will fluctuate in the same increase/decrease direction. Therefore, it is possible to cancel out the fluctuation. On the other hand, the fluctuation in the 3.3 VDC does not affect the first sensor voltage, but only the first reference voltage. However, it is possible to suppress detection errors caused by using the plurality of power supplies by making the resistance value of the second resistor Re sufficiently larger than the resistance value of the first resistor Ra. In addition, the ENG 3.3 V, which is used as the drive voltage for the fixing temperature sensor TH1 and also as the first reference voltage for the first comparator 221, is also the drive voltage for the nip detection sensor SE3 configured to detect whether the fuser 9 is in the pressure contact state or the separation state. Therefore, it is possible to achieve a cost reduction by making the number of power supplies less than the number of sensors and comparators. In addition, the ENG 3.3 V, which is used as the drive voltage for the fixing temperature sensor TH1 and also as the first reference voltage for the first comparator 221, is also the drive voltage for the discharge sensor SE4 configured to detect whether the sheet S with the developer image fixed thereon by the fuser 9 has been discharged. Therefore, it is possible to achieve a cost reduction by making the number of power supplies less than the number of sensors and comparators.

### Second Illustrative Embodiment

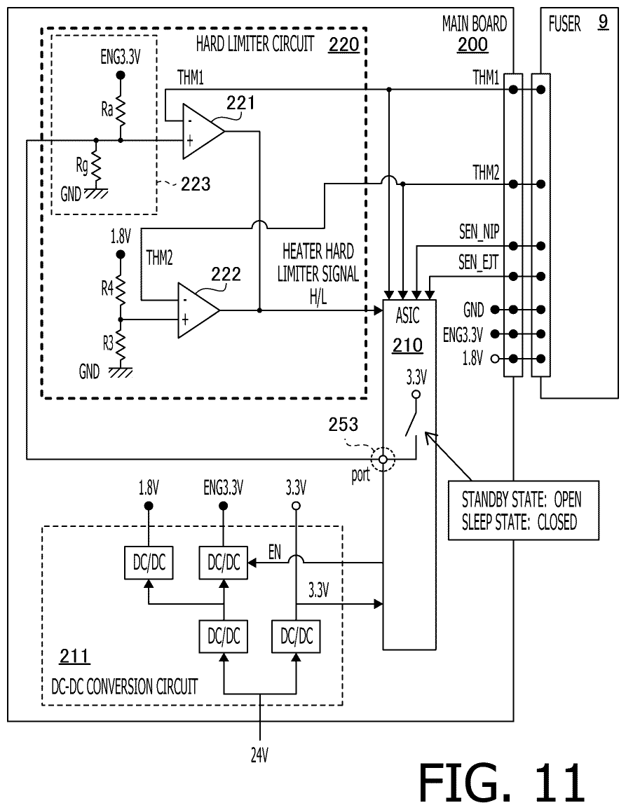

Next, a printer in a second illustrative embodiment according to aspects of the present disclosure will be described with reference to FIG. 11. In the following description of the second illustrative embodiment, the same reference numerals as used in FIGS. 1 to 10 to describe the configuration of the printer 1 in the aforementioned first illustrative embodiment represent substantially the same (or equivalent) elements as those of the printer 1 in the first illustrative embodiment.

A general configuration of the printer in the second illustrative embodiment is substantially the same as that of the printer 1 in the aforementioned first illustrative embodiment. In addition, various control processes in the second illustrative embodiment are substantially the same as those for the printer 1 in the first illustrative embodiment. However, with respect to the electrical configuration of the hard limiter circuit 220 shown in FIG. 9 among the features of the printer 1 in the first illustrative embodiment, the printer in the second illustrative embodiment has a different configuration.

With reference to FIG. 11, a more detailed explanation will be provided below of an electrical configuration of a hard limiter circuit 220 in the second illustrative embodiment. FIG. 11 specifically extracts and illustrates only the electrical configuration of the hard limiter circuit 220 provided on the main board 200 and a related electrical configuration of the printer 1.

As shown in FIG. 11, the hard limiter circuit 220 in the second illustrative embodiment differs from the aforementioned first illustrative embodiment in a configuration of a reference voltage generation circuit 223 configured to generate a first reference voltage to be input to a non-inverting input terminal (+) of a first comparator 221 for, in particular, a fixing temperature sensor TH1. On the other hand, a configuration of a second comparator 222 in the second illustrative embodiment is substantially the same as in the first illustrative embodiment.

As shown in FIG. 11, the reference voltage generation circuit 223 in the second illustrative embodiment includes a first resistor Ra and a second resistor Rg. One end of the first resistor Ra is connected to an ENG 3.3 V power supply (hereinafter, which may be referred to as a “first power supply”). One end of the second resistor Rg is connected to the ground GND. The other ends of the first resistor Ra and the second resistor Rg are connected at a junction. The voltage applied to the junction is input to the non-inverting input terminal (+) as a first reference voltage. On the other hand, the ASIC 210 includes an output terminal (e.g., a port) 253 and a 3.3 VDC power supply (hereinafter, which may be referred to as a “particular power supply”). Thus, the ASIC 210 is enabled to switch a connection state between the output terminal 253 and the 3.3 VDC power supply.

Specifically, the ASIC 210 controls the connection state between the output terminal 253 and the 3.3 VDC power supply as follows. When the printer 1 is in the “standby state” (i.e., the non-power-saving mode), the ASIC 210 sets the connection state to “open (i.e., disconnected).” When the printer 1 is in the “sleep state” (i.e., the power-saving mode), the ASIC 210 sets the connection state to “closed (i.e., connected).”

In substantially the same manner as in the first illustrative embodiment, in the second illustrative embodiment as well, the supply of ENG 3.3 V is stopped when the printer 1 is in the “sleep state” (i.e., the power-saving mode). Specifically, as shown in FIG. 11, a signal EN from an output port of the ASIC 210 is input to a DC-DC conversion circuit 211. When the printer 1 is in the standby state (including during the execution of printing), the ASIC 210 sets the value of the signal EN to H (ON), thereby instructing the DC-DC conversion circuit 211 to output ENG 3.3 V Conversely, when the printer 1 is in the sleep state, the ASIC 210 sets the value of the signal EN to L (OFF), thereby instructing the DC-DC conversion circuit 211 not to output ENG 3.3 V.

Therefore, if the first reference voltage Vd is input only from the ENG 3.3 V power supply, when the printer 1 enters the sleep state, the first reference voltage Vd to be input to the non-inverting input terminal (+) and the first sensor voltage Vin to be input to the inverting input terminal (−) will both become 0 V. This may result in an indeterminate non-output logic state and a risk of false detection (e.g., a possibility that the L signal may be transmitted as the heater hard limiter signal even though the temperature of the heating roller 91 is sufficiently low). However, in the second illustrative embodiment, the non-inverting input terminal (+) to which the first reference voltage Vd is input is also connected to the output port of the ASIC 210 in addition to the ENG 3.3 V power supply. Therefore, when the printer 1 enters the sleep state, 3.3 VDC (hereinafter, which may be referred to as a “particular voltage”) is supplied from the output port of the ASIC 210. Thus, at least the voltage from the ASIC 210 is still input to the non-inverting input terminal (+) even when the printer 1 is in the sleep state. As a result, the first reference voltage Vd does not become 0 V, thereby ensuring a definite output logic and inhibiting such false detection.

The first reference voltage Vd, to be input to the non-inverting input terminal (+) when the printer 1 is in the “standby state” (i.e., the non-power-saving mode), is expressed by the following equation (5).

$$Vd = Rg \times ( ENG 3.3 V ) / ( Ra + Rg ) \qquad ( 5 )$$

It is noted that “Ra” and “Rg” in the equation (5) represent the respective resistance values of the first resistor Ra and the second resistor Rg.

On the other hand, the first reference voltage Vd, to be input to the non-inverting input terminal (+) when the printer 1 is in the “sleep state” (i.e., the power-saving mode), is expressed by the following equation (6).

$$Vd = 3.3 VDC \qquad ( 6 )$$

On the other hand, an electrical configuration with respect to the second comparator 222 is substantially the same as in the first illustrative embodiment. For a reference voltage to be input to the non-inverting input terminal (+) of the second comparator 222, as shown in FIG. 11, the non-inverting input terminal (+) of the second comparator 222 is connected to the 1.8 VDC power supply (hereinafter, which may be referred to as a “second power supply”). A voltage obtained by dividing 1.8 V by the resistors R3 and R4 is input to the non-inverting input terminal (+) as a second reference voltage. The second reference voltage Vd to be input to the non-inverting input terminal (+) is expressed by the above equation (4).

As described in detail above, the printer 1 in the second illustrative embodiment includes the reference voltage generation circuit 223 configured to generate the first reference voltage to be input to the non-inverting input terminal (+) of the first comparator 221. The reference voltage generation circuit 223 includes the first resistor Ra and the second resistor Rg. One end of the first resistor Ra is connected to the ENG 3.3 V power supply. One end of the second resistor Rg is connected to the ground GND. The other ends of the first resistor Ra and the second resistor Rg are connected at the junction. The voltage applied to the junction is input to the non-inverting input terminal (+) as the first reference voltage. The ASIC 210 includes the output terminal (e.g., a port) 253 and the 3.3 VDC power supply. The ASIC 2110 is configured to input the voltage of 3.3 VDC from the 3.3 VDC power supply to the junction of the reference voltage generation circuit 223 via the output terminal 253, depending on the switching of the connection state between the output terminal 253 and the 3.3 VDC power supply. When the printer 1 is in the standby state, the output terminal 253 and the 3.3 VDC power supply are disconnected from each other. When the printer 1 is in the sleep state, the output terminal 253 and the 3.3 VDC power supply are connected to each other. Therefore, even if the voltage supply from the ENG 3.3 V power supply is stopped in response to the printer 1 entering the sleep state, the first reference voltage does not become 0 V because of the voltage supplied from the ASIC 210, thereby ensuring a definite output logic and inhibiting false detection by the first comparator.

### Third Illustrative Embodiment

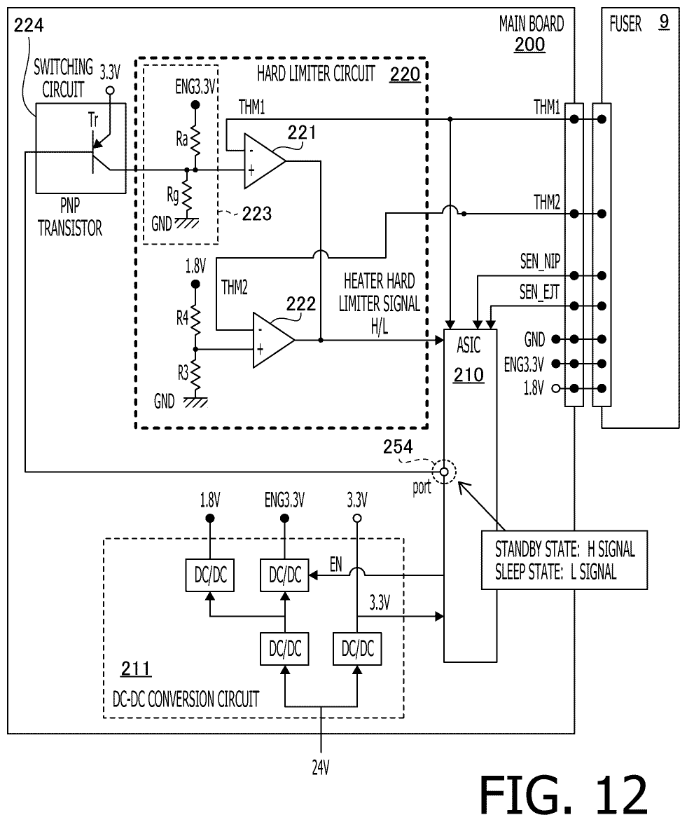

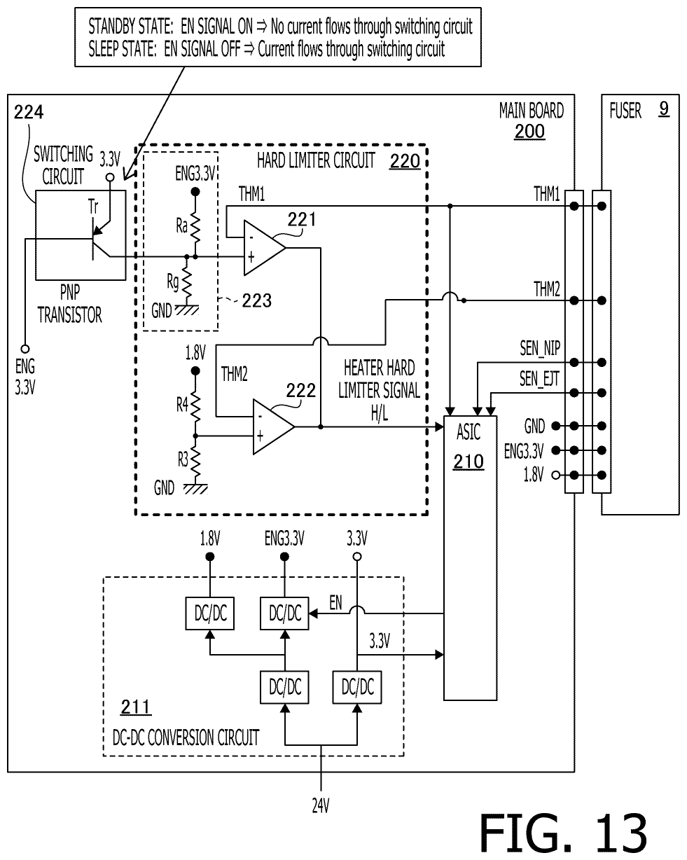

Next, a printer in a third illustrative embodiment according to aspects of the present disclosure will be described with reference to FIG. 12. In the following description of the third illustrative embodiment, the same reference numerals as used in FIGS. 1 to 10 to describe the configuration of the printer 1 in the aforementioned first illustrative embodiment represent substantially the same (or equivalent) elements as those of the printer 1 in the first illustrative embodiment.

A general configuration of the printer in the third illustrative embodiment is substantially the same as that of the printer 1 in the aforementioned first illustrative embodiment. In addition, various control processes in the third illustrative embodiment are substantially the same as those for the printer 1 in the first illustrative embodiment. However, with respect to the electrical configuration of the hard limiter circuit 220 shown in FIG. 9 among the features of the printer 1 in the first illustrative embodiment, the printer in the third illustrative embodiment has a different configuration.

With reference to FIG. 12, a more detailed explanation will be provided below of an electrical configuration of a hard limiter circuit 220 in the third illustrative embodiment. FIG. 12 specifically extracts and illustrates only the electrical configuration of the hard limiter circuit 220 provided on the main board 200 and a related electrical configuration of the printer 1.

As shown in FIG. 12, the hard limiter circuit 220 in the third illustrative embodiment differs from the aforementioned first illustrative embodiment in a configuration of a reference voltage generation circuit 223 configured to generate a first reference voltage to be input to a non-inverting input terminal (+) of a first comparator 221 for, in particular, a fixing temperature sensor TH1. On the other hand, a configuration of a second comparator 222 in the third illustrative embodiment is substantially the same as in the first illustrative embodiment.

As shown in FIG. 12, the reference voltage generation circuit 223 in the third illustrative embodiment includes a first resistor Ra and a second resistor Rg. One end of the first resistor Ra is connected to an ENG 3.3 V power supply (hereinafter, which may be referred to as a “first power supply”). One end of the second resistor Rg is connected to the ground GND. The other ends of the first resistor Ra and the second resistor Rg are connected at a junction. The voltage applied to the junction is input to the non-inverting input terminal (+) as a first reference voltage. On the other hand, the main board 200 includes a switching circuit 224 configured to control whether to apply the voltage from the 3.3 VDC power supply (hereinafter, which may be referred to as a “particular power supply”) provided on the main board 200 to the junction.

The switching circuit 224 includes a PNP transistor. A base of the PNP transistor is connected to an output terminal (e.g., a port) 254 of the ASIC 210. An emitter of the PNP transistor is connected to the 3.3 VDC power supply provided on the main board 200. A collector of the PNP transistor is connected to the junction of the hard limiter circuit 220. The switching circuit 224 is configured to switch the PNP transistor on or off in response to an H signal or an L signal from the ASIC 210, thereby switching whether the voltage from the 3.3 VDC power supply is applied to the junction of the hard limiter circuit 220.

In substantially the same manner as in the first illustrative embodiment, in the third illustrative embodiment as well, the supply of ENG 3.3 V is stopped when the printer 1 is in the “sleep state” (i.e., power-saving mode). Specifically, as shown in FIG. 12, a signal EN is input to the DC-DC conversion circuit 211 from an output port of the ASIC 210. When the printer 1 is in the standby state (including during the execution of printing), the ASIC 210 sets the value of the signal EN to H (ON), thereby instructing the DC-DC conversion circuit 211 to output ENG 3.3 V Conversely, when the printer 1 is in the sleep state, the ASIC 210 sets the value of the signal EN to L (OFF), thereby instructing the DC-DC conversion circuit 211 not to output ENG 3.3 V.

Therefore, if the first reference voltage Vd is input only from the ENG 3.3 V power supply, when the printer 1 enters the sleep state, the first reference voltage Vd to be input to the non-inverting input terminal (+) and the first sensor voltage Vin to be input to the inverting input terminal (−) will both become 0 V. This may result in an indeterminate non-output logic state and a risk of false detection (e.g., a possibility that the L signal may be transmitted as the heater hard limiter signal even though the temperature of the heating roller 91 is sufficiently low). However, in the third illustrative embodiment, the non-inverting input terminal (+) to which the first reference voltage Vd is input is also connected to the switching circuit 224 in addition to the ENG 3.3 V power supply. Therefore, when the printer 1 enters the sleep state, 3.3 VDC (hereinafter, which may be referred to as a “particular voltage”) is supplied from the switching circuit 224. Thus, at least the voltage from the switching circuit 224 is still input to the non-inverting input terminal (+) even when the printer 1 is in the sleep state. As a result, the first reference voltage Vd does not become 0 V, thereby ensuring a definite output logic and inhibiting such false detection.

Specifically, when the printer 1 is in the standby state, the ASIC 210 outputs an H signal to the switching circuit 224. The H signal (i.e., 3.3 V) from the ASIC 210 is applied to the base of the PNP transistor. Therefore, no electric current flows from the emitter to the base of the PNP transistor since the emitter and the base have substantially the same potential. Namely, when the printer 1 is in the standby state, the PNP transistor disconnects the hard limiter circuit 220 from the 3.3 VDC power supply. On the other hand, when the printer 1 is in the standby state, the value of the signal EN transmitted from the ASIC 210 to the DC-DC conversion circuit 211 is H (ON). Therefore, the voltage from the ENG 3.3 V power supply provided on the reference voltage generation circuit 223 is output to the non-inverting input terminal (+). As described above, when the printer 1 is in the standby state, the ASIC 210 provides the switching circuit 224 with an instruction not to input the voltage from the 3.3 VDC power supply connected to the emitter of the PNP transistor to the non-inverting input terminal (+), while providing an instruction to output the voltage from the ENG 3.3 V power supply provided on the reference voltage generation circuit 223 to the non-inverting input terminal (+).

The first reference voltage Vd, to be input to the non-inverting input terminal (+) when the printer 1 is in the “standby state” (i.e., the non-power-saving mode), is expressed by the following equation (7).

$$Vd = Rg \times ( ENG 3.3 V ) / ( Ra + Rg ) \qquad ( 7 )$$

It is noted that “Ra” and “Rg” in the equation (7) represent the respective resistance values of the resistors Ra and Rg.

On the other hand, when the printer 1 is in the sleep state, the ASIC 210 outputs the L signal to the switching circuit 224. The L signal (0 V) from the ASIC 210 is input to the base of the PNP transistor. Therefore, an electric current flows from the emitter to the base of the PNP transistor, since the emitter potential is 3.3 V, and the base potential is 0 V and lower than the emitter potential. Then, an electric current flows from the emitter to the collector of the PNP transistor. Thus, when the printer 1 is in the sleep state, the PNP transistor connects the 3.3 VDC power supply to the hard limiter circuit 220. On the other hand, when the printer 1 is in the sleep state, the value of the signal EN transmitted from the ASIC 210 to the DC-DC conversion circuit 211 is L (OFF). Therefore, the voltage from the ENG 3.3 V power supply provided on the reference voltage generation circuit 223 is no longer output to the non-inverting input terminal (+). s described above, when the printer 1 is in the sleep state, the ASIC 210 provides the switching circuit 224 with an instruction to input the voltage from the 3.3 VDC power supply connected to the emitter of the PNP transistor to the non-inverting input terminal (+), while providing an instruction not to output the voltage from the ENG 3.3 V power supply provided on the reference voltage generation circuit 223 to the non-inverting input terminal (+).

The first reference voltage Vd, to be input to the non-inverting input terminal (+) when the printer 1 is in the “sleep state” (i.e., the power-saving mode), is expressed by the following equation (8).

$$Vd = 3.3 VDC \qquad ( 8 )$$

On the other hand, the second comparator 222 has substantially the same configuration as in the first illustrative embodiment. Specifically, as shown in FIG. 12, the non-inverting input terminal (+) of the second comparator 222 is connected to the 1.8 VDC power supply (hereinafter, which may be referred to as a “second power supply”). The voltage obtained by dividing 1.8 V by the resistors R3 and R4 is then input to the non-inverting input terminal (+) as the second reference voltage. The second reference voltage Vd to be input to the non-inverting input terminal (+) is expressed by the above equation (4).

As described in detail above, the printer 1 in the third illustrative embodiment includes the reference voltage generation circuit 223 configured to generate the first reference voltage to be input to the non-inverting input terminal (+) of the first comparator 221. The reference voltage generation circuit 223 includes the first resistor Ra and the second resistor Rg. One end of the first resistor Ra is connected to the ENG 3.3 V power supply. One end of the second resistor Rg is connected to the ground GND. The other ends of the first resistor Ra and the second resistor Rg are connected at the junction. The voltage applied to the junction is input to the non-inverting input terminal (+) as the first reference voltage. The printer 1 further includes the switching circuit 224 and the ASIC 210. The switching circuit 224 is configured to control whether to apply 3.3 VDC to the junction. The ASIC 210 is configured to control the switching circuit 224. When the printer 1 is in the standby state, the ASIC 210 provides the switching circuit 224 with an instruction not to input the voltage from the 3.3 VDC power supply connected to the emitter of the PNP transistor to the non-inverting input terminal (+), while providing an instruction to output the voltage from the ENG 3.3 V power supply provided on the reference voltage generation circuit 223 to the non-inverting input terminal (+). When the printer 1 is in the sleep state, the ASIC 210 provides the switching circuit 224 with an instruction to input the voltage from the 3.3 VDC power supply connected to the emitter of the PNP transistor to the non-inverting input terminal (+), while providing an instruction not to output the voltage from the ENG 3.3 V power supply provided on the reference voltage generation circuit 223 to the non-inverting input terminal (+). Thus, even when the printer 1 enters the sleep state, and the voltage supply from the ENG 3.3 V power supply is stopped, the voltage from the switching circuit 224 is input to the non-inverting input terminal (+) by the ASIC 210. As a result, the first reference voltage Vd does not become 0 V, thereby ensuring a definite output logic and inhibiting false detection by the first comparator.

### Fourth Illustrative Embodiment

Next, A printer in a fourth illustrative embodiment according to aspects of the present disclosure will be described with reference to FIG. 13. In the following description of the fourth illustrative embodiment, the same reference numerals as used in FIGS. 1 to 10 to describe the configuration of the printer 1 in the aforementioned first illustrative embodiment represent substantially the same (or equivalent) elements as those of the printer 1 in the first illustrative embodiment.

A general configuration of the printer in the fourth illustrative embodiment is substantially the same as that of the printer 1 in the aforementioned first illustrative embodiment. In addition, various control processes in the fourth illustrative embodiment are substantially the same as those for the printer 1 in the first illustrative embodiment. However, with respect to the electrical configuration of the hard limiter circuit 220 shown in FIG. 9 among the features of the printer 1 in the first illustrative embodiment, the printer in the fourth illustrative embodiment has a different configuration.

With reference to FIG. 13, a more detailed explanation will be provided below of an electrical configuration of a hard limiter circuit 220 in the fourth illustrative embodiment. FIG. 13 specifically extracts and illustrates only the electrical configuration of the hard limiter circuit 220 provided on the main board 200 and a related electrical configuration of the printer 1.

As shown in FIG. 13, the hard limiter circuit 220 in the fourth illustrative embodiment differs from the aforementioned first illustrative embodiment in a configuration of a reference voltage generation circuit 223 configured to generate a first reference voltage to be input to a non-inverting input terminal (+) of a first comparator 221 for, in particular, a fixing temperature sensor TH1. On the other hand, a configuration of a second comparator 222 in the fourth illustrative embodiment is substantially the same as in the first illustrative embodiment.

As shown in FIG. 13, the reference voltage generation circuit 223 in the fourth illustrative embodiment includes a first resistor Ra and a second resistor Rg. One end of the first resistor Ra is connected to an ENG 3.3 V power supply (hereinafter, which may be referred to as a “first power supply”). One end of the second resistor Rg is connected to the ground GND. The other ends of the first resistor Ra and the second resistor Rg are connected at a junction. The voltage applied to the junction is input to the non-inverting input terminal (+) as a first reference voltage. On the other hand, the main board 200 includes a switching circuit 224 configured to control whether to apply the voltage from the 3.3 VDC power supply (hereinafter, which may be referred to as a “particular power supply”) provided on the main board 200 to the junction, depending on whether the voltage is output from the ENG 3.3 V power supply.

The switching circuit 224 includes a PNP transistor. A base of the PNP transistor is connected to the ENG 3.3 V power supply. An emitter of the PNP transistor is connected to the 3.3 VDC power supply provided on the main board 200. A collector of the PNP transistor is connected to the junction of the hard limiter circuit 220. The switching circuit 224 is configured to switch the PNP transistor on or off in conjunction with whether the voltage is output from the ENG 3.3 V power supply, thereby switching whether the voltage from the 3.3 VDC power supply is applied to the junction of the hard limiter circuit 220.

In substantially the same manner as in the first illustrative embodiment, in the fourth illustrative embodiment as well, the supply of ENG 3.3 V is stopped when the printer 1 is in the “sleep state” (i.e., the power-saving mode). Specifically, as shown in FIG. 13, a signal EN is input from an output port of the ASIC 210 to the DC-DC conversion circuit 211. When the printer 1 is in the standby state (including during the execution of printing), the ASIC 210 sets the value of the signal EN to H (ON), thereby instructing the DC-DC conversion circuit 211 to output ENG 3.3 V. Conversely, when the printer 1 is in the sleep state, the ASIC 210 sets the value of the signal EN to L (OFF), thereby instructing the DC-DC conversion circuit 211 not to output ENG 3.3 V.

Therefore, if the first reference voltage Vd is input only from the ENG 3.3 V power supply, when the printer 1 enters the sleep state, the first reference voltage Vd to be input to the non-inverting input terminal (+) and the first sensor voltage Vin to be input to the inverting input terminal (−) will both become 0 V. This may result in an indeterminate non-output logic state and a risk of false detection (e.g., a possibility that the L signal may be transmitted as the heater hard limiter signal even though the temperature of the heating roller 91 is sufficiently low). However, in the fourth illustrative embodiment, the non-inverting input terminal (+) to which the first reference voltage Vd is input is also connected to the switching circuit 224 in addition to the ENG 3.3 V power supply. Therefore, when the printer 1 enters the sleep state, 3.3 VDC (hereinafter, which may be referred to as a “particular voltage”) is supplied from the switching circuit 224. Thus, at least the voltage from the switching circuit 224 is still input to the non-inverting input terminal (+) even when the printer 1 is in the sleep state. As a result, the first reference voltage Vd does not become 0 V, thereby ensuring a definite output logic and inhibiting such false detection.

Specifically, when the printer 1 is in the standby state, the ENG 3.3 V is applied to the base of the PNP transistor in the switching circuit 224. Therefore, no current flows from the emitter to the base of the PNP transistor since the emitter and the base have substantially the same potential. Namely, when the printer 1 is in the standby state, the PNP transistor disconnects the hard limiter circuit 220 from the 3.3 VDC power supply. Meanwhile, when the printer 1 is in the standby state, the value of the signal EN transmitted from the ASIC 210 to the DC-DC conversion circuit 211 is H (ON). Therefore, the voltage from the ENG 3.3 V power supply provided on the reference voltage generation circuit 223 is output to the non-inverting input terminal (+). Thus, when the printer 1 is in the standby state, the ENG 3.3 V power supply is controlled to output the voltage, thereby controlling the voltage from the 3.3 VDC power supply connected to the emitter of the PNP transistor not to be input to the non-inverting input terminal (+).

The first reference voltage Vd, to be input to the non-inverting input terminal (+) when the printer 1 is in the “standby state” (i.e., the non-power-saving mode), is expressed by the following equation (9).

$$Vd = Rg \times ( ENG 3.3 V ) / ( Ra + Rg ) \qquad ( 9 )$$

It is noted that “Ra” and “Rg” in the equation (9) represent the respective resistance values of the resistors Ra and Rg.

On the other hand, when the printer 1 is in the sleep state, 0 V is input to the base of the PNP transistor in the switching circuit 224. Therefore, an electric current flows from the emitter to the base, since the emitter potential is 3.3 V, and the base potential is 0 V and lower than the emitter potential. Consequently, an electric current flows from the emitter to the collector of the PNP transistor. Thus, when the printer 1 is in the sleep state, the 3.3 VDC power supply is connected to the hard limiter circuit 220. Meanwhile, when the printer 1 is in the sleep state, the value of the signal EN transmitted from the ASIC 210 to the DC-DC conversion circuit 211 is L (OFF). Therefore, the voltage from the ENG 3.3 V power supply provided on the reference voltage generation circuit 223 is no longer output to the non-inverting input terminal (+). Thus, when the printer 1 is in the sleep state, the ENG 3.3 V power supply is controlled not to output the voltage, thereby controlling the voltage from the 3.3 VDC power supply connected to the emitter of the PNP transistor not to be input to the non-inverting input terminal (+).

The first reference voltage Vd, to be input to the non-inverting input terminal (+) when the printer 1 is in the “sleep state” (i.e., the power-saving mode), is expressed by the following equation 10.

$$Vd = 3.3 VDC \qquad ( 10 )$$

On the other hand, the second comparator 222 has substantially the same configuration as in the first illustrative embodiment. Specifically, as shown in FIG. 13, the non-inverting input terminal (+) of the second comparator 222 is connected to the 1.8 VDC power supply (hereinafter, which may be referred to as a “second power supply”). The voltage obtained by dividing 1.8 V by the resistors R3 and R4 is then input to the non-inverting input terminal (+) as the second reference voltage. The second reference voltage Vd to be input to the non-inverting input terminal (+) is expressed by the above equation (4).

As described in detail above, the printer 1 in the fourth illustrative embodiment includes the reference voltage generation circuit 223 configured to generate the first reference voltage to be input to the non-inverting input terminal (+) of the first comparator 221. The reference voltage generation circuit 223 includes the first resistor Ra and the second resistor Rg. One end of the first resistor Ra is connected to the ENG 3.3 V power supply. One end of the second resistor Rg is connected to the ground GND. The other ends of the first resistor Ra and the second resistor Rg are connected at the junction. The printer 1 further includes the switching circuit 224 configured to control whether to apply 3.3 VDC to the junction, depending on whether ENG 3.3 V is output. When the printer 1 is in the standby state, the switching circuit 224 is controlled not to apply 3.3 VDC to the junction due to ENG 3.3 V being output. Meanwhile, when the printer 1 is in the sleep state, the switching circuit 224 is controlled to apply 3.3 VDC to the junction due to ENG 3.3 V not being output. Thus, even when the printer 1 enters the sleep state, and the voltage supply from the ENG 3.3 V power supply is stopped, the voltage from the switching circuit 224 is applied to the non-inverting input terminal (+). As a result, the first reference voltage Vd does not become 0 V, thereby ensuring a definite output logic and inhibiting false detection by the first comparator.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

For instance, in the aforementioned illustrative embodiments, the physical quantities compared with the reference voltages by the hard limiter circuit 220 are the temperatures detected by the fixing temperature sensors TH1 and TH2 configured to detect the temperatures of the heating roller 91. However, practicable examples of the physical quantities compared with the reference voltages are not limited to these, but may include physical quantities detected by sensors other than the fixing temperature sensors TH1 and TH2.

In the aforementioned illustrative embodiments, the first comparator 221 is associated with the fixing temperature sensor TH1, and the second comparator 222 is associated with the fixing temperature sensor TH2. However, the first comparator 221 may be associated with the fixing temperature sensor TH2, and the second comparator 222 may be associated with the fixing temperature sensor TH1.

In the aforementioned illustrative embodiments, the first reference voltage to be input to the non-inverting input terminal (+) of the first comparator 221 is generated by the reference voltage generation circuit 223 including the ENG 3.3 V power supply (i.e., the first power supply). However, the first reference voltage may be generated by the reference voltage generation circuit 223 or may be generated directly from the output from the ENG 3.3 V power supply (i.e., the first power supply).

In the aforementioned illustrative embodiments, the fuser 9 is configured to be removably attached to the main body housing 2 of the printer 1. However, the fuser 9 may be configured to be fixedly attached to the main body housing 2 of the printer 1.

In the aforementioned illustrative embodiments, the printer 1 has been described as an example of the “image forming apparatus” according to aspects of the present disclosure. However, examples of the “image forming apparatus” according to aspects of the present disclosure may include, but are not limited to, a copier, a facsimile machine, and a multi-function peripheral having a printing function and a scanning function.

The following provides examples of associations between elements depicted in the aforementioned illustrative embodiment(s) and modification(s), and elements claimed according to aspects of the present disclosure. For instance, the printer 1 may be an example of an “image forming apparatus” according to aspects of the present disclosure. The fixing temperature sensor TH1 may be an example of a “first sensor” according to aspects of the present disclosure. The first comparator 221 may be an example of a “first comparator” according to aspects of the present disclosure. The inverting input terminal (−) of the first comparator 221 may be an example of a “first sensor input terminal” according to aspects of the present disclosure. The non-inverting input terminal (+) of the first comparator 221 may be an example of a “first reference voltage input terminal” according to aspects of the present disclosure. The ENG 3.3 V power supply may be an example of a “first power supply” according to aspects of the present disclosure. The fixing temperature sensor TH2 may be an example of a “second sensor” according to aspects of the present disclosure. The second comparator 222 may be an example of a “second comparator” according to aspects of the present disclosure. The inverting input terminal (−) of the second comparator 222 may be an example of a “second sensor input terminal” according to aspects of the present disclosure. The non-inverting input terminal (+) of the second comparator 222 may be an example of a “second reference voltage input terminal” according to aspects of the present disclosure. The 1.8 VDC power supply may be an example of a “second power supply” according to aspects of the present disclosure. The ASIC 210 may be an example of a “controller” according to aspects of the present disclosure. The process unit 4 may be an example of an “image forming engine” according to aspects of the present disclosure. The fuser 9 may be an example of a “fuser” according to aspects of the present disclosure. The heating roller 91 may be an example of a “heating rotatable body” according to aspects of the present disclosure. The pressure roller 92 may be an example of a “pressure rotatable body” according to aspects of the present disclosure. The heater 93 may be an example of a “heater” according to aspects of the present disclosure. The fuser connector 160 may be an example of a “fuser terminal” according to aspects of the present disclosure. The relay 203D may be an example of a “relay” according to aspects of the present disclosure. The 3.3 VDC power supply may be an example of a “particular power supply” according to aspects of the present disclosure. The reference voltage generation circuit 223 may be an example of a “reference voltage generation circuit” according to aspects of the present disclosure. The switching circuit 224 may be an example of a “switching circuit” according to aspects of the present disclosure. The flange 121B of the cam gear 121 included in the pressure contact/separation mechanism may be an example of a “gear” included in a “pressure contact/separation mechanism” according to aspects of the present disclosure. The nip detection sensor SE3 may be an example of a “state detection sensor” according to aspects of the present disclosure, and may be an example of a “nip detection sensor” according to aspects of the present disclosure. The discharge sensor SE4 may be an example of a “discharge sensor” according to aspects of the present disclosure.

What is claimed is:

1. An image forming apparatus comprising:
a first sensor configured to detect a first physical quantity of the image forming apparatus and to output a first sensor voltage corresponding to the detected first physical quantity;
a first comparator comprising:
a first sensor input terminal configured to receive the first sensor voltage from the first sensor; and
a first reference voltage input terminal configured to receive a first reference voltage, the first comparator being configured to compare the first sensor voltage with the first reference voltage and to output a first output signal when the first sensor voltage exceeds the first reference voltage; and
a first power supply configured to be turned on or off depending on whether the image forming apparatus is in a first mode or a second mode that consumes less power than the first mode, thereby outputting a specific voltage when the image forming apparatus is in the first mode, and not outputting the specific voltage when the image forming apparatus is in the second mode, the specific voltage being used to generate the first sensor voltage and the first reference voltage.

2. The image forming apparatus according to claim 1, further comprising:
a second sensor configured to detect a second physical quantity of the image forming apparatus and to output a second sensor voltage corresponding to the detected second physical quantity;
a second comparator comprising:
a second sensor input terminal configured to receive the second sensor voltage from the second sensor; and
a second reference voltage input terminal configured to receive a second reference voltage, the second comparator being configured to compare the second sensor voltage with the second reference voltage and to output a second output signal when the second sensor voltage exceeds the second reference voltage;
a second power supply configured to output the second reference voltage; and
a controller configured to receive the first output signal and the second output signal.

3. The image forming apparatus according to claim 2, further comprising:
an image forming engine configured to form a developer image on a sheet; and
a fuser configured to fix the developer image formed on the sheet, the fuser comprising:
a heating rotatable body configured to heat the sheet;
a pressure rotatable body configured to nip the sheet between the pressure rotatable body and the heating rotatable body;
a fuser terminal configured to receive an AC voltage from a commercial power supply; and
a heater connected to the fuser terminal via a relay,
wherein the first sensor is further configured to detect a temperature of a first region of the heating rotatable body,
wherein the second sensor is further configured to detect a temperature of a second region, different from the first region, of the heating rotatable body, and
wherein the controller is further configured to cause the relay to be disconnected when at least one of a first condition, in which the controller has received the first output signal from the first comparator, or a second condition, in which the controller has received the second output signal from the second comparator, is satisfied.

4. The image forming apparatus according to claim 1, further comprising a particular power supply configured to output a particular voltage,
wherein the first reference voltage input terminal of the first comparator is further configured to receive at least the specific voltage when the image forming apparatus is in the first mode, and to receive at least the particular voltage when the image forming apparatus is in the second mode.

5. The image forming apparatus according to claim 4, further comprising a reference voltage generation circuit configured to generate the first reference voltage to be input to the first reference voltage input terminal, the reference voltage generation circuit comprising:
a first resistor having one end connected to the first power supply;
a second resistor having one end connected to the particular power supply; and
a third resistor having one end connected to ground,
wherein the other ends of the first resistor, the second resistor, and the third resistor are connected at a junction, and
wherein a voltage applied to the junction is input to the first reference voltage input terminal as the first reference voltage.

6. The image forming apparatus according to claim 4, further comprising:
a reference voltage generation circuit configured to generate the first reference voltage to be input to the first reference voltage input terminal, the reference voltage generation circuit comprising:
a first resistor having one end connected to the first power supply; and
a second resistor having one end connected to ground, wherein the other ends of the first resistor and the second resistor are connected at a junction, and a voltage applied to the junction is input to the first reference voltage input terminal as the first reference voltage; and
a controller comprising an output terminal and the particular power supply, the controller being configured to:
control whether the particular voltage output from the particular power supply is applied to the junction of the reference voltage generation circuit via the output terminal, depending on a connection state between the output terminal and the particular power supply; and
disconnect the output terminal from the particular power supply when the image forming apparatus is in the first mode, and connect the output terminal to the particular power supply when the image forming apparatus is in the second mode.

7. The image forming apparatus according to claim 4, further comprising:
a reference voltage generation circuit configured to generate the first reference voltage to be input to the first reference voltage input terminal, the reference voltage generation circuit comprising:
a first resistor having one end connected to the first power supply; and
a second resistor having one end connected to ground, wherein the other ends of the first resistor and the second resistor are connected at a junction, and a voltage applied to the junction is input to the first reference voltage input terminal as the first reference voltage;
a switching circuit configured to control whether to apply the particular voltage to the junction; and
a controller configured to:
inhibit the switching circuit from applying the particular voltage to the junction and cause the first power supply to output the specific voltage, when the image forming apparatus is in the first mode; and
cause the switching circuit to apply the particular voltage to the junction and inhibit the first power supply from outputting the specific voltage, when the image forming apparatus is in the second mode.

8. The image forming apparatus according to claim 4, further comprising:
a reference voltage generation circuit configured to generate the first reference voltage to be input to the first reference voltage input terminal, the reference voltage generation circuit comprising:
a first resistor having one end connected to the first power supply; and
a second resistor having one end connected to ground, wherein the other ends of the first resistor and the second resistor are connected at a junction, and a voltage applied to the junction is input to the first reference voltage input terminal as the first reference voltage; and
a switching circuit configured to control whether the particular voltage is applied to the junction based on whether the specific voltage is output, thereby inhibiting the particular voltage from being applied to the junction when the first power supply outputs the specific voltage in the first mode of the image forming apparatus, and causing the particular voltage to be applied to the junction when the first power supply does not output the specific voltage in the second mode of the image forming apparatus.

9. The image forming apparatus according to claim 1, further comprising:
an image forming engine configured to form a developer image on a sheet; and
a fuser configured to fix the developer image formed on the sheet, the fuser comprising:
a heating rotatable body configured to heat the sheet;
a pressure rotatable body configured to nip the sheet between the pressure rotatable body and the heating rotatable body;
a pressure contact/separation mechanism comprising a gear and configured to switch between a pressure contact state, in which the heating rotatable body and the pressure rotatable body are in pressure contact with each other, and a separation state, in which the heating rotatable body and the pressure rotatable body are separated from each other; and
a nip detection sensor configured to detect whether the pressure contact/separation mechanism is in the pressure contact state or the separation state,
wherein the first sensor is further configured to detect a temperature of the heating rotatable body, and
wherein the specific voltage is further used to drive the nip detection sensor.

10. The image forming apparatus according to claim 1, further comprising:
an image forming engine configured to form a developer image on a sheet; and
a fuser configured to fix the developer image formed on the sheet, the fuser comprising a heating rotatable body configured to heat the sheet; and
a discharge sensor configured to detect whether the sheet with the developer image formed thereon has been discharged,
wherein the first sensor is further configured to detect a temperature of the heating rotatable body, and
wherein the specific voltage is further used to drive the discharge sensor.
